(19) United States
(12) Patent Application Publication
(10) Pub. No.: US 2005/0289505 A1
(43) Pub. Date: Dec. 29, 2005

(54) Method and system for improving performance and scalability of applications that utilize a flow-based-programming methodology

(76) Inventor: Stanley Norman Williams, Whitby (CA)

Correspondence Address: DATA MASTERS (CANADA) LTD., 19 POGSON DRIVE, WHITBY, ON, L1R 2J1, CA

(21) Appl. No.: 10/876,321

(22) Filed: Jun. 25, 2004

(51) Int. Cl. G06F 9/44

(52) U.S. Cl. 717/103

(57) ABSTRACT

A method, system, apparatus, and computer program product is presented for improving the execution performance of flow-based-program (FBP) programs and improving the execution performance further on systems with additional processing resources (scalability). A FBP supervisor is inserted as the initial executable program, which program will interrogate the features of the operating system upon which it is executing including but not limited to number of processors, memory capacity, auxiliary memory capacity (paging dataset size), and networking capabilities. The supervisor will create an optimum number of processing environments (e.g. threads in a Windows environment) to service the user FBP application. The supervisor will further expose other services to the FBP application which improve the concurrent execution of the work granules (processes) within that FBP application. The supervisor further improves the generation and logging of messages through structured message libraries which are extended to the application programmer. The overall supervisor design maximizes concurrency, eliminates unnecessary work, and offers services so a process should suspend rather than block.

### 1 DESCRIPTION

### 1.1 BACKGROUND OF THE INVENTION

1.1.1 Field of the Invention

The present invention relates to computers, an improved data processing system, and in particular to a method and framework which enhances the public domain “Flow Based Programming” (FBP) method.

1.1.2 Orientation

FBP is a paradigm focusing on data flowing between processes which act upon that data as compared to the prevailing “von Neumann” paradigm with its single application program acting on a few streams of data.

The present invention is the many enhancements to the public description of FBP that make it a viable productivity tool for todays and tomorrows computing environments. The new supervisor and supported techniques permit features such as automatic multi-processing, distributed processing, real-time processing, hosted functions, enhanced synchronization, and reduced switching overhead.

As the “Integrated Circuit” made efficient “black boxes” of discreet electronic circuits, the present invention makes efficient “black boxes” of today's programming. Early FBP usage shows that a large percentage of a new project may use prepackaged, and tested, routines, requiring programming of a small part of the application. Business analysts, not programmers, design the application and specify the unique processes required. Programmers develop these unique processes restricting themselves to input and output specifications. One process has no direct affect on another process running in the same application other than the data passed between them.

Reuse, the target of “Object Oriented” techniques, is the premise of FBP and the present invention.

The present invention creates an efficient environment for software development and productive implementation. The invention permits more work to be performed with less overhead, and eliminates circumstances where the computer waits for services while other work may be performed.

Packaging and protection of intellectual property is enhanced by shipping DLLs and compiled networks.

1.1.3 Description of Related Art

The present invention enhancements to FBP create an efficient environment for software development and productive implementation. The enhancements permit more work to be performed with less overhead, eliminates circumstances where the computer waits for services while other work may be performed, and permits ‘non dataflow mapped’ calls to functions and services such as display services or database handling.

Packaging and protection of intellectual property is enhanced by shipping DLLs and compiled networks.

The practical advantages of FBP over conventional programming are significant. Coupled with the present invention, development shops may now:
Significantly reduce time from design to production through use of prepackaged routines and networks
Significantly reduce error rate through use of pre-tested standard routines.
Engage business analysts to develop the business flow diagrams and engage programmers to develop non standard routines

The present invention offers many additional supervisor options over basic FBP. Many enhancements come with the supervisor; others are available to programmers in their designs. Features are demonstrated by open source sample processes.

Programmers who work with multi-threading and multi-processor systems know the complexities involved in their development. The present invention has this support inherent in the supervisor design. A “program” may be moved from a single processor system to a multiple processor system with no changes. The system will allocate the available resources without program changes.

Execution times are reduced through inherent overlap of operations. The supervisor recognizes whether the operating system can support synchronous or asynchronous I/O operations. Traditional systems will “block” during synchronous I/O, the present invention passes these requests to special threads that may block without stopping the main services. Event/Wait/Check services permit the process to direct attention to other non blocking activities and significantly improve overlap of operations.

The present invention also recognizes memory mapped temporary files, eliminating unnecessary temporary I/O operations thereby improving overall performance.

Event/Wait/Post/Check services permit a process to know when its output stream is becoming full and directs attention to other non blocking activities. An event may be set and posted when the downstream process is again ready to handle data.

Dispatching (suspend, queue, re-dispatch) adds significant overhead for processes that do little work on much data (granular processes). The present invention includes Information Packet (IP) port services which permit more productivity and efficient use of resources through pushing IPs through a chain of downstream exits without incurring the overhead of dispatching.

A process may contain functions that are called from other processes. These functions are not connected by the normal port structure; the supervisor locates and prepares a function when a process “opens” the function name. The “names” of functions are registered in their containing DLL.

1.1.4 Details of a Practical Example

It is difficult to pick one example for a paradigm shift that is applicable to entire Information Technology (IT) shops. Examples range from real-time video stream manipulation, distributed scientific calculations (data is split into serviceable packets, shipped along with executables to remote systems, and recombined after processing), to database update/query programs running on application servers. An example below is for an automatic archival system.

Environment:
Microsoft Windows 2000 server environment
Managed service handling FAX, EMAIL and EDI translations requiring previous month's data to be available, but moved away from the current production drives.
Gigabytes of data processed each month for hundreds of customers

Data Layout:
Production drive with hundreds of customers and directories. Hundred thousands of files and gigabytes of data.
Archival drive containing the previous month's data plus a control file indicating when the data was transferred (used to prevent overlay and premature deletion)
Control file pointing to directories, retention period information, and archive/backup flags. Archived files will be deleted from the source location when not used since the previous month and deleted from the archival location when not used since the second previous month. Backup files will be maintained in both locations. i.e. don't erase a control file just because it hasn't been changed for several months.

Standard services utilized:
Enumerate—Develop bracketed streams of files matching input streams of directory descriptors.
Enumerate contains a function available for downstream process to interpret the data stream.
FileRead—Efficiently read control files and gigabytes of data. Same routine used many times, written and tested long before this application was designed.
FileWrite—Efficiently write the data. Same routine used to write reports, control files, and the gigabytes of user data
IPDump—Write a debug log of traffic passing between two services. Standard routine that may be used for testing. Capture the stream during a production run and “replay” the stream for later testing.

Custom services:
Prepare—Read the control files (determines what directories to handle, and processing options) and pass requests to Enumerate. Pass control information to Run
Run—Receive streams of file and control information about the source, target, and target control locations. Determine what files to erase, copy, or move.

### 1.2 BRIEF SUMMARY OF THE INVENTION

The present invention enhances the public domain FBP paradigm with a dynamically scalable, high throughput, performance oriented supervisor. The present invention addresses these general performance areas:
1. Utilizes available hardware processing power from single processor computers to those containing arrays of processors. This is done with no changes to the program. Conventional programming requires sophisticated techniques to utilize one additional processor; the present invention applies these techniques, via the supervisor, to every user invocation.
2. A priority dispatcher determines which ready process (one that is not blocked by the supervisor for capacity or external operations) to run. There is one execution thread dedicated to every physical processor.
3. Input/Output operations (I/O) account for most idle time in conventional programming, during which the physical processor is often idle. Overlapped I/O is difficult to program and some operating systems (e.g. Microsoft Windows 98 and earlier) do not offer it. The present invention moves physical I/O into the supervisor and makes all I/O appear asynchronous and overlapped with other processing.
The supervisor uses asynchronous I/O if available and if not, starts a thread just for that I/O permitting it to block rather than the supervisor or user process. The user process operates the same for real I/O (either mode) or memory backed temporary files. Control is passed back to the user process immediately where it may do other processing and check/wait on completion later.
Performing I/O to a temporary file incurs substantial wait time. The present invention utilizes available main memory, backed by the paging dataset or a real file, to hold the data. The supervisor calls are the same as the other I/O services except they operate directly on memory.
4. Conventional I/O operations operate through an operating system cache algorithm. Caching works well for smaller files if they are to be processed frequently but utilizes valuable resources (processor and memory) for larger or infrequently accessed files. All data is processed twice (double buffered), once being read into the cache and again when it is transferred to the user's data area.
The present invention, when requested by routines such as the supplied samples FileRead and FileWrite, will use “virtual buffers”. The operating system will read/write a system defined block of data, or multiples of blocks, directly into the user buffer. This halves the memory requirements and the data is moved only once. It also improves the system cache performance by eliminating idle file memory.
5. The present invention dispatcher normally “suspends” a process when the present request cannot be completed due to capacity (e.g. Input port is empty) or physical (e.g. an I/O operation has not ended) constraints.
In line with the underlining goal to keep running whenever there is work to do, the calling process may pass an “event” on the service request. In this case the supervisor will not suspend but return with a code indicating the event has been “set”. The process may now do other work and later “check” (wait or test options) if the event has been “posted”. The process may potentially have a number of outstanding events and may “wait” on them individually or specify a list and wait for the first one to be posted. The supervisor will suspend the caller, until the event is posted, and dispatch another process that is waiting to run.
6. FBP systems may “deadlock” due to programming error or capacity issues (e.g. a Split/Process/Merge network with Input port queue counts too low). The present invention includes deadlock processing services that attempt to keep the network running.
Users may specify “NoWorkList” exits that gain control on potential deadlock conditions. Demonstration code (in MakeIP) creates a batch of work then goes idle. Eventually that batch will finish all downstream processing and the network will go idle. Deadlock processing will go to the exit (in MakeIP) where it will initiate another batch of work.
Deadlock processing also contains capacity services. Whenever a system deadlocks with a queue capacity problem, that part of the network has a “Dynamic Buffering” routine inserted. Dynamic Buffering will insert large holding areas and resume the upstream process. Should that same part of the network deadlock again the holding areas are compressed. After many compressed blocks are built the routine starts writing the areas to the paging dataset or a real file. It will unwind the data when the downstream process starts drawing the data. Dynamic Buffering may be considered an “infinite queue” but is only invoked when nothing else in the system can run.
7. Time critical networks, such as real time video processing, may require parts of the network to run faster than others. The present invention offers a “Priority Boost” (boost may also be a negative value) where specific time dependant processes may have their priority changed to better meet service requirements, and non critical services have their priority lowered to reduce interference.
8. Processes may be “stitched” into a network as required for debugging or for load balancing. An example is a user monitor may insert IPDUMP routines before and after a questionable routine. This may happen without stopping the application. The stitched routine(s) may be later “unstitched” when the condition clears.
9. FBP fosters a high level of reuse. The FileRead process mentioned above may have many instances in the network. Each copy will run independently of the others.
The present invention permits a sub network to be defined once and used many times within the network. They may be many levels deep or even call themselves (with great care). When defined in the network definition they are called “sub networks” and greatly aid readability.
The present invention permits a network to be predefined and stored in a library much as a process. This type of “dynamic network” will be initialized when first called and will remove itself from the system when complete. Seldom used transaction routines make ideal dynamic networks.
10. Many (thousands) of active processes, each creating messages will, without intervention, produce an unreadable message log. Each message may have a slightly different structure again making the log difficult to read and impossible to post process with a program. Other issues include stock messages and multiple languages.
The present invention has an extensive “Message Service”. A thread-safe message processing routine produces time accurate logs in a consistent format. It ensures each message is complete and not mixed with another message.
Messages are, most often, initiated by specifying a message number, trace level information, and substitution variables. The message is pushed onto a message queue and the Message Service takes over from there producing the log. Messages may be hard coded in the process but frequently have the message specified in a message library.
The message service supports a hierarchy of message libraries from the active process, through the network, application library, ending at the supervisor library. The first occurrence of the message number is used for formatting. This structure supports multiple languages including a variable substitution mask in the message. Messages may be printed, printed on error only, or ignored according to the message flags and the active trace level. This is all handled by the message service.
11. The present invention includes real time file change monitoring. Many processes may monitor activity on many different directories. Each opens an input port specifying the directory or directories to be monitored. The supervisor will create data packets whenever a file changes on a monitored directory and will put those notifications in the input port. Normal input port processing, from the process view, is maintained.
12. The present invention includes a method to push data to a process's input port turbo exit without dispatching the target process. A single dispatch of a system “Turbo” process will push data through a network of exits stopping at a normal port where the data is queued for normal process dispatch and pull processing.
The turbo exits reduce system overhead through reduced dispatching, no changing of IP ownership, and elimination of input port queuing.
13. The present invention contains a major deviation from FBP architecture by introducing named functions which may be called by any process without being defined in a network diagram. These functions may perform any service and may be defined to run in simple or double-call modes. Two real examples are:
The file structure “Enumerate” process can generate a complex bracketed stream of directory and file information. It offers a function to decode the stream and, when used by a downstream process significantly simplifies programming. The decoding of the data stream is inside the same process that creates the data stream. These simple call functions run under the calling process dispatch.
The “FileRead” process exposes double-call functions. The first call establishes the environment and schedules a dispatch of the host process which “opens” the file, and primes data buffers. The second call type transfers data under control of the calling process which transfers prepared data to the caller's data buffers. When a buffer is emptied the host function is signaled to prepare additional data.

### 1.3 BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1A depicts a typical computer architecture that may be used within a server in which programs are not using this invention. It shows “von Neumann” style programming and how many resources are not being utilized.

FIG. 1B depicts a typical computer architecture that may be used within a server in which programs are using this invention. It shows FBP programming with the present invention and how resources are being utilized concurrently.

FIG. 2A depicts the control blocks that manage the hardware. There is one INVOCATION and SYSTEM control block created when the invention is invoked. They control the local system. Additional SYSTEM control blocks are allocated when connections to remote computers are established to manage hardware items on the remote computer(s). A PROCESSOR control block, and execution thread, is created for every effective hardware processor on the system. A single CPU with multiple effective processors will create multiple PROCESSOR control blocks e.g. Intel P4 processors with hyper-threading (circa 2004) count as two.

FIG. 2B depicts the control blocks that manage each active user application/program. One APPLICATION is created at program start and exists for the life of the program. Using the built-in $NET_BUILD application, one NETWORK control block is built for each network found. One PROCESS control block is created for each process found within each network, and linked from the NETWORK. One MESSAGE_LIBRARY is created for each library found, and linked to the appropriate PROCESS, NETWORK, APPLICATION, or SYSTEM. Also during build, for every port defined in the networks, an INPUT/OUTPUT PORT is created and linked to the appropriate processes. During execution a running process may create information packets (IPs) which carry information between processes.

FIG. 2C depicts the control blocks joining one process to another. An OutPort block is created for each output port defined in the network, likewise an InPort for each input port defined. Network build creates a Destination block for each output port and links them from the downstream input port. This structure supports multiple output ports being connected to one input port.

FIG. 2D depicts various ways IPs may be linked. First a simple string of packets is shown, Then a tree structure of IPs where one IP is passed but that IP contains a logical structure of pointers to other packets.

FIG. 2E depicts the control blocks built for each data library referenced (DLLs in Windows). Every library is scanned for processes, functions, and a message library. The target type, name, entry point, and other information are saved in hashed tables, by name, for fast retrieval.

FIG. 3 depicts the performance supervisor (the present invention), a single process (the supplied FileRead sample), and the interaction between them.

FIG. 4A illustrates how a process requests I/O services without waiting for them to end, performs other work, then checks to see if the I/O has completed. The performance supervisor cannot run asynchronously so uses a blocking synchronous thread to perform the I/O while giving the appearance and performance of non blocking I/O to the process.

FIG. 4B illustrates the same flow as FIG. 3A except the I/O can run asynchronously. The user process still has the appearance and performance of non blocking I/O. The supervisor has less overhead but still delivers the same service.

FIG. 4C illustrates the same flow as FIG. 4A except the I/O is performed entirely in the operating system memory. The user process still has the appearance and performance of non blocking I/O. The exact same code is performed by the FileRead process in 4A, 4B, and 4C.

FIG. 5A illustrates the overhead, and advantage for small frequently referenced files, when processing data through a cache structure. A simple read has data passed through at least two buffers, and processing code to transfer appropriate portions of that data between the buffers.

FIG. 5B shows how to use only the user data buffer for I/O operations. FileRead is specifically written to handle this method. It is great for large or seldom used files. Files already in the cache will not be found and will be read in again.

FIGS. 6A-6C are a set of figures depicting the advantages of the present invention over von Neumann techniques on a single processor system capable of synchronous I/O only. It then shows how multiple processors and asynchronous I/O further enhance performance.

FIGS. 7A-7B illustrate how the performance supervisor uses a familiar process for all I/O operations regardless of what the supervisor must do to service those requests.

FIG. 8A shows how a process may use an event to achieve overlapped data send and other processing. It shows how the receiving process affects the event, without knowing it is there, and how the sending process is affected.

FIG. 8B is an extension of FIG. 8A showing how the sending process may manipulate multiple ports, both sending and receiving, and be alerted whenever any one of those ports have pending work (receive) or now have space to accept more data (send). This permits maximum overlap of operations.

FIGS. 9A-9B are a set of figures depicting how a system may deadlock, or stall. These are normally programming or network design errors.

FIG. 9C depicts the user specifying a deadlock/no work exit and how the performance supervisor will pass control to that exit when nothing else in the network can run. This routine may be an analysis routine, or in this example, creates a batch of work.

FIG. 9D illustrates the performance supervisor preventing a capacity deadlock by activating a dynamic buffering service on the input port of a blocked process. This happens at deadlock detection when a candidate process is waiting on one (empty) port while another input port is full.

FIG. 10A illustrates how a control routine may request priority changes within a network to maintain some timing criteria.

FIG. 10B depicts an example of stitching in debug routines around a failing routine.

FIGS. 11A-11D illustrate how a network may be shown on paper, coded in a simple network, make multiple references to a defined sub network, and utilize a library dynamic network.

FIG. 12 illustrates how the Performance Supervisor Services request information packets (IP), how pools of free IPs are maintained, and the guard feature.

FIGS. 13A-13C are a set of figures depicting how messages are originated concurrently from multiple processes and how the Message Service is organized. Shown is the selection order for message libraries, and an example of a message log.

FIG. 14 illustrates how real time file monitoring is integrated into the input port processing service.

FIGS. 15A-B are a set of figures illustrating push mode port I/O processing referred to as Turbo Port Processing. First is the overview of how a process may push data down through several layers of process exits. Second are the control block extensions behind the process.

FIGS. 16A-B are a set of figures relating to Functions. They show the flow and control blocks built for non-hosted functions and for hosted functions. The Function Block is a class created by an open request. It contains a “Call” method described below.

FIG. 16C illustrates how a process may call a function in a different compilation. A non-hosted call will branch directly to the code and run under the dispatch of the calling process.

FIGS. 16D-E illustrate the control blocks created for hosted functions. These functions run asynchronously under system created processes not network connected to anything, utilizing work queues. The single call method is for stand-alone requests, the double call method permits work to be started in one call and the results obtained in another. A file read example demonstrates how one call readies the control blocks and starts I/O operations while subsequent calls extract data from buffers returned by the read.

### 1.4 DETAILED DESCRIPTION OF THE INVENTION

1.4.1 The Invention and Conventional Programming

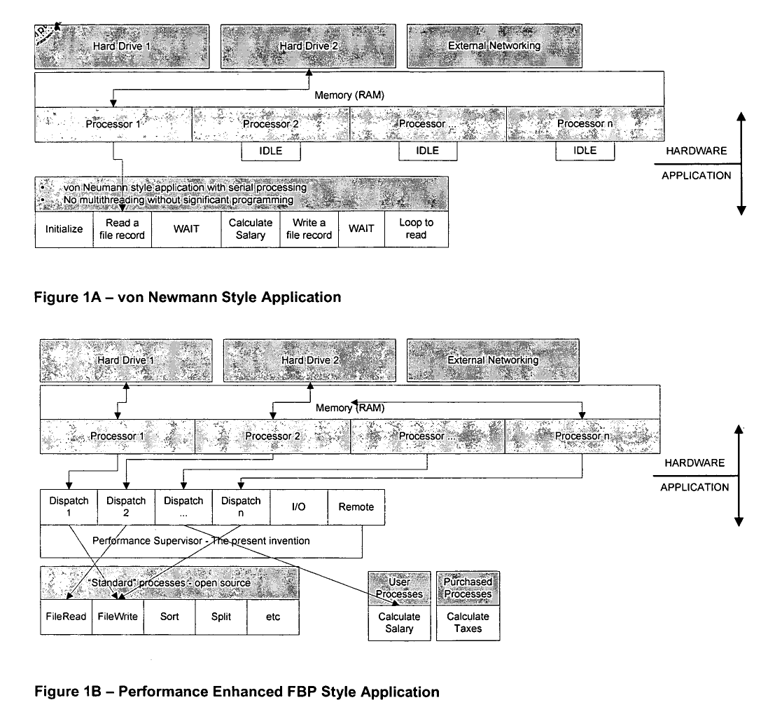

With reference now to the figures, FIG. 1A-B depict a typical server environment with two processors, each capable of “hyper-threading” with the resulting appearance of 4 processors. FIG. 1A depicts a conventional program which is written in conventional von Neumann style; that being a single executable written in program centric style. The example application will request data, perform some operation on that data, and write it out for later processing.

FIG. 1B depicts an example program written to use this invention, enhancements to Flow Based Programming (FBP), comprising a supervisor, a selection of pre-written mini-applications (processes) that come with this invention, one purchased process, and one user written process. This application is data centric, in which the data and its flow are controlled by the supervisor according to network definitions. A process is given control when it has data ready on its input port (INPORT) and no output port (OUTPORT), if any, has filled to capacity. In this network, many processes may be ready to run; the supervisor selects which one to give control.

In FIG. 1A the operating system assigns one processor to the only application thread. The remaining 3 processors will stay idle. This thread will initiate a read operation for the first data then wait for the operating system to supply that data. Once the data is available it will perform some calculations and write the record for future processing and again wait until the operation is complete. The program then loops back to the read, continuing until no more data is available. Most of the time the only “active” processor is waiting on input/output (I/O) operations to complete. Very little time is actually spent running the application.

In FIG. 1B this invention will start sufficient threads to utilize all available hardware processors, four in this case. Each will select a ready process and give it control. In this example the four selected processes are:
One FileRead process, located in the standard library, which is designed to read an input file in the most efficient manner and create information packets (IP) for later processing.
One Calculate Salary process, which is user written, which acts upon its supplied IP chain filling in the salary and tax information.
Two instances of FileWrite which efficiently write the input IP chain(s) to disk dataset(s). Each instance of FileWrite has a different parameter string specifying a different target dataset and works on a different stream of IPs. The single code copy is reused. There may be hundreds of concurrent ready copies of the same code segment, in this example with only 4 dispatchers, a maximum of 4 copies may be actually executing at the same time.

FIG. 1B also shows activity on two hard drives, and processing into memory. With 4 active processes and special I/O services, multiple concurrent operations may occur to physical hard drives and to memory backed temporary files.

There are two levels of programming in a FBP application. The first is network design in which a “Business Analyst” establishes the business rules through defining processes and the flow of data that connects them. The analyst selects from catalogues of standard processes and, when no process exists to meet the business need, requests the programming of application specific (user) processes. Each process is written with its own “core competency”. For example, the FileRead process in this diagram is designed to read data in the most efficient manner, and once written and tested, will not require any effort or testing to consistently maintain that efficiency.

1.4.2 The Physical/Hardware Environment

1.4.2.1 Representing the Hardware Platform

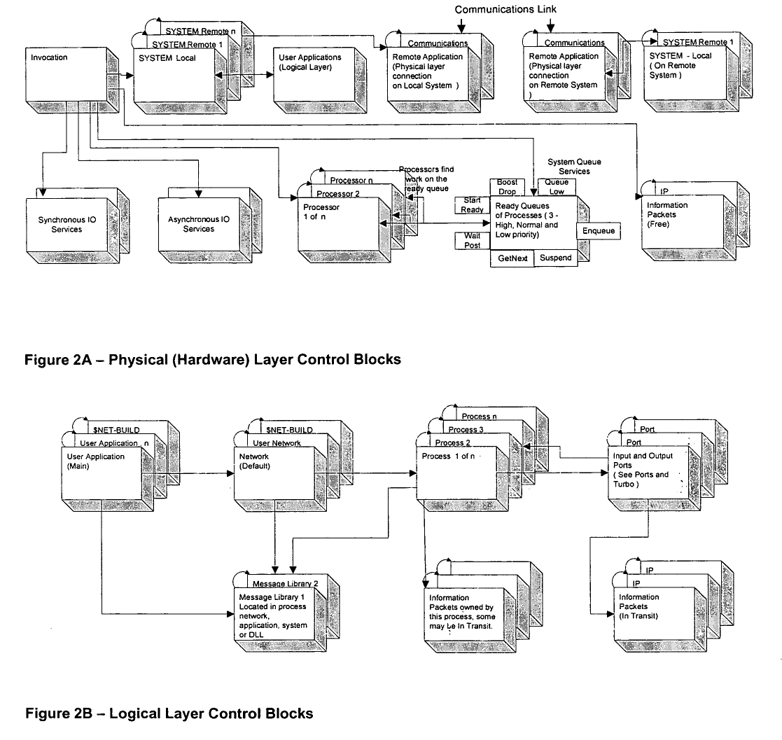

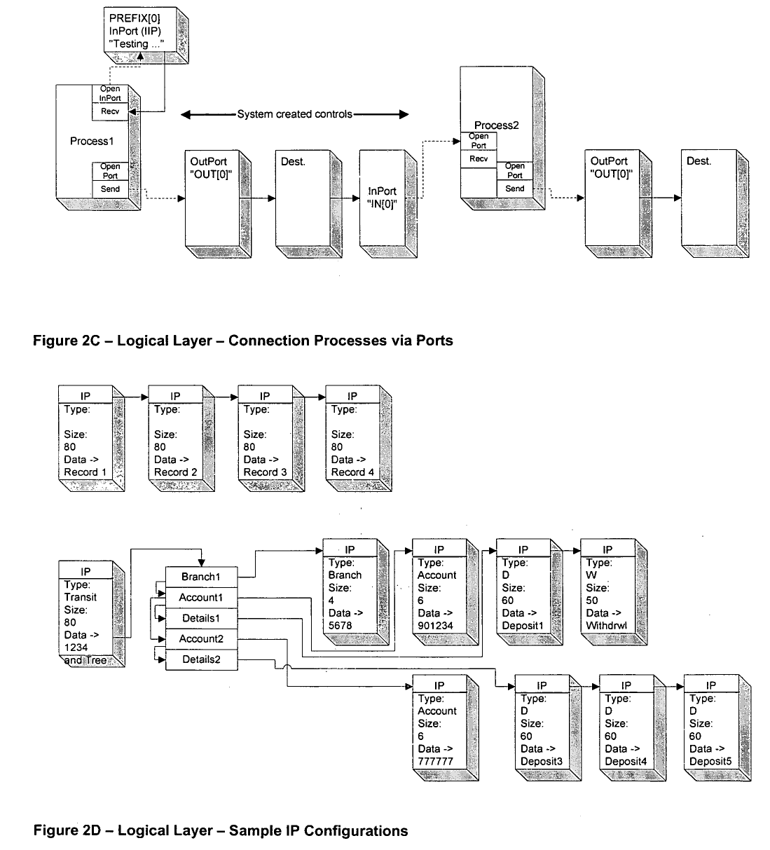

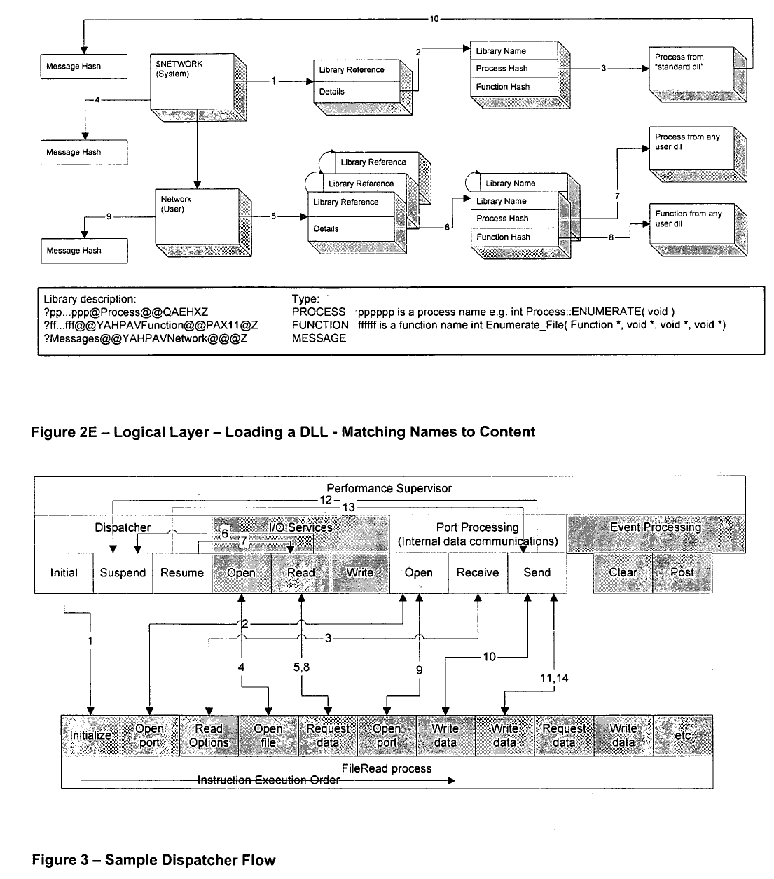

With reference to FIG. 2A, this invention establishes a number of internal control blocks representing this physical computer and physical connections to other computers on which one or more applications have active networks.

One INVOCATION control block is created when the program starts whether from a program.EXE or as a system service. The Invocation block is the root of all control blocks in the invention and has a presence available to all supervisor functions. It has linkage to:
Controls for each processor started
The dispatcher, service routines around the dispatcher, and associated ready queues
The I/O subsystem threads, services, and associated pending/active queues
IP obtain and free services, pools of free IPs, and associated main storage queues
The message services and their associated queues
Synchronization controls for multi-threaded service interactions
System identification including number of physical processors, type and version of host operating system, other environment information as reported by the operating system.
The host class for dispatcher and I/O services.

1.4.2.2 Representing this System and Distributed Systems

One SYSTEM control block is created as the root for all LOGICAL layer information representing the system on which this invocation is running. There may be additional SYSTEM controls created during operation, each representing a remote hardware/software platform upon which at least one local application is distributed. An example would be a connection to this invention running on a database server.

For distributed processing, each SYSTEM control has a special application layer containing standardized services providing distributed system communications and data exchange. Types of data exchanged may be networks and process code, message libraries, log messages, and IPs. Data on the link may be compressed to improve overall performance. FIG. 2A shows multiple distributed systems connected to this invocation and only one distributed connection (the invocation being examined) on the remote system.

The SYSTEM control is the root class for all APPLICATION control blocks, see Logical Layer following, which are running on this system.

1.4.2.3 Using the Hardware Processors

By default, one PROCESSORTHREAD control is created for every physical processor on this computer. Each PROCESSORTHREAD has an associated thread which is an independent dispatcher. In addition to information regarding the associated thread is information relating to the particular PROCESS, see Logical Layer, which is being dispatched. For example, the dispatcher saves its working registers in this control before loading the dispatched process controls. Each PROCESSORTHREAD also contains synchronization controls so a service may alert this idle dispatcher that new work exists on a ready queue.

This invention does not assign each thread to a particular hardware processor; it creates just enough to fully utilize the available hardware when the host operating system has no other work for the hardware processors.

There is no need to over-allocate processors due to the nature of this invention's architecture in which all potential blocking calls are made in the supervisor and the supervisor will suspend the active process, make not ready, and request the dispatcher to find another ready process. The architecture is to never block a thread until there is no work pending when the dispatcher blocks until alerted that more work is available. The host operating system dispatcher will select another application outside this invention, or give control to one of the specialty threads within this invention.

1.4.2.4 The I/O Supervisor

The I/O supervisor was established for several reasons including:
Waiting for external I/O is the reason most programs block execution. Once blocked that program will do nothing until the I/O completes. It requires significant programming around every I/O operation to achieve overlapped operation. This invention has moved all the special processing into the supervisor resulting in the active process suspending but the physical processor remains busy performing the work of other processes, i.e. another process is dispatched.
Some operating systems do not support true asynchronous I/O operations, where others do. The I/O supervisor will pass requests to one of two types of processing according to the physical hardware, and host operating system.
Special memory simulated I/O operations are utilized for temporary files, when main memory is underutilized. Using memory instead of physical I/O has a significant performance improvement.
Bypassing the system cache reduces system overhead for large files. The supervisor will invoke “Virtual Buffer” processing for files which, if processed normally, would have the host operating system cache perform unnecessary work and occupy memory with unnecessary data.

The calling process sees every operation as fully asynchronous and overlapped. It may request up to four concurrent operations per file, have concurrent read and write operations, and CHECK the operations requesting SUSPEND or be notified of the status. The process does not know which method the I/O supervisor selected to perform the actual I/O.

The I/O request is made to common routine which will make a determination of which type of service to utilize. All requests, the associated IOCONTROLs, are pushed into the appropriate Pending I/O Queue using thread-safe techniques. The appropriate thread is alerted to new work and is responsible for selecting the next operation to start.

The service thread will dechain the entire new-work push down chain, using thread-safe techniques, sort them into chronological sequence according to priority, merge the resulting chain into any already pending work, and select the current top entry. Processing of this entry is done according to the type of supervisor, as described below.

1.4.2.4.1 Asynchronous I/O Services

Available when the host operating system, file subsystem, and characteristics of the target file permit, the I/O request may utilize asynchronous I/O techniques. This invention will create one asynchronous thread and the associated operating system exits required to most efficiently utilize the infrastructure.

The process request will be passed to the asynchronous I/O supervisor where the requesting IOCONTROL is interrogated, the physical I/O initiated, and when the operation does not end immediately the IOCONTROL is placed in an active queue for the asynchronous I/O exit routine.

In either case control is returned to the calling process immediately so it may perform other work.

The host operating system will pass control to the exit when the requested I/O operation completes. There the request is marked complete, and if the requesting process has suspended it will be marked READY and placed on the READY QUEUE for subsequent dispatch. When one or more PROCESSORTHREAD dispatchers are idle, they will be woken to select and RESUME the now ready process.

The Asynchronous IO supervisor is the most efficient handler for physical I/O as it can handle many concurrent I/O operations with one thread and has a host operating system level exit performing post I/O cleanup and dispatch.

1.4.2.4.2 Synchronous I/O Services

When physical I/O is required and the host operating cannot handle asynchronous requests the Synchronous I/O supervisor is selected. The I/O supervisor will start a special thread if:
No synchronous I/O threads are currently waiting for work
The limit of these threads has not been reached. This limit is adjusted by the dispatcher to achieve a balance between overhead and overlapped operations.

These threads are designed to block during active I/O operations, but since they are isolated from all other operations, they do not stop other processes from running.

1.4.2.4.3 Memory Backed I/O Services

These services differ from Asynchronous and Synchronous as no threads or queuing are required. They are performed when the calling process makes the request and, in the current version of the invention, may on rare occasion block the active thread due to paging activity.

These services are most often selected when the calling process requests operations with temporary files. The process will issue identical requests as for physical I/O, and the supervisor may reroute the request to one of the physical I/O services when memory is constrained.

WRITE requests will validate allocated memory, allocate it if needed, and transfer the buffer into memory. READ requests will retrieve data from memory, and SEEK requests will reposition the memory pointer for subsequent READ or WRITE requests.

1.4.2.5 The Dispatcher

Dispatcher services are actually many routines working against the ready queue and processes residing in the logical layer.

1.4.2.5.1 The Ready Queue

There are actually three ready queues; one for High priority process; one for Medium priority; one for Low priority. Each entry is a PROCESSCONTROL control block which represents the physical layer for each logical layer PROCESS. They are ordered in priority and chronological sequence within the three broad priority groupings. Each dispatcher service works on the PROCESSCONTROL whether on the ready queue or not. Services are:

1.4.2.5.2 Enqueue

The Enqueue service call is made by other services whenever they request a process be made ready. Each queue has a thread-safe new work push down chain which Enqueue uses to pass new work to the dispatcher. Enqueue interrogates the INVOCATION active and limit dispatcher counts and, when there are one or more idle dispatchers, signals one of them to wake-up and process the new work. If all dispatchers are active, the next one to look for work will check the new-work chain.

1.4.2.5.3 GetNext

This routine is called by each dispatcher thread when it either was woken by Enqueue, or has suspended an active process and is looking for more work. GetNext may return one of these conditions:
The address of a PROCESSCONTROL to be given control, i.e. to RESUME
A NULL to indicate no work is available and should block until woken by Enqueue.
A EOF condition when the last process has terminated and it is time for each dispatcher to return
A DEADLOCK condition indicating that no work is available, all processes have not ended and no processes are pending I/O or other known blocking services. The dispatcher must determine if any deadlock service is requested, or terminate execution in error.

GetNext will dechain any pending new work entries, and if found, will merge the requests into the existing ready queues. Requests of the same priority will be placed in chronological order, i.e. at the end of any matching priority entries. GetNext will then select the top request on the chain and return it to the calling dispatcher. It may return any of the above conditions depending on queue and system status.

1.4.2.5.4 QueueLow

This service will check the ready queue and if any entries exist at the current priority or above:
SUSPEND the current process
Place the current PROCESSCONTROL in the ready queue in the appropriate priority position, after any entries of equal priority
Signal the dispatcher to call GetNext for additional work

This service is used for load balancing and may be called directly by the running process. If this process is currently the top priority it will return doing nothing. SUSPEND and RESUME of the same process is unnecessary overhead.

1.4.2.5.5 Priority Boost

This service will change the current dispatching priority of the associated PROCESSCONTROL. The boost value may be positive for priority increase, or negative for priority decrease. A call to QueueLow will be made to SUSPEND the active process when other ready processes are of equal or higher priority.

1.4.2.5.6 Wait/Post

These event based services may change the current status of a process. A wait request will interrogate the associated list and if no events are marked complete will call SUSPEND to end current process execution. If one or more events are marked complete the wait will be satisfied and the routine will return immediately. A POST, from another service, will mark the associated event as complete and if wait conditions are satisfied issue an ENQUEUE request. The dispatcher will return immediately after the SUSPEND call and wait will return to the calling process

Wait may be specified to operate on one entry or a list of entries. It may be specified to wait on from 1 to all entries in the list.

Details on how services use events are explained later in the “Events” section

1.4.2.5.7 StartReady

This service is used to “kick-start” the dispatcher. It is called when a new network is introduced to the system and will scan that network for any processes ready to run. It normally runs once during initialization and once when “Dynamic Networks” are called.

An Enqueue is issued for each ready process found. Once put on the Ready Queue these processes will be dispatched and suspended until they complete.

1.4.3 The Logical/Software Environment

1.4.3.1 Understanding the Logical Layer

Refer to FIG. 2B for the Logical Layer control blocks and environment. The executable portions, PROCESS(s), are grouped within networks, which are owned by the application.

A PROCESS has input ports, INPORT(s), from which it receives information packets (IPs) and output ports, OUTPORT(s), to which it sends IPs. The outport of one process is connected to the inport of another process according to the logic specified in the containing network

1.4.3.2 The Application

The APPLICATION control block is the connection between the physical layer SYSTEM control block and the logical layer. One is created for each application running on this INVOCATION. For program.EXE invocations there is normally only one user APPLICATION.

The APPLICATION has a list of user networks that are active, and a list of dynamic networks that may, or may not, be currently active.

Every invocation has one reserved $NET-BUILD application which is invoked at initialization to prepare the logical layer for startup. $NET-BUILD contains several specialized processes that read the user network definition, build and link the requested networks, processes, and ports, then calls the dispatcher StartReady service to begin execution.

1.4.3.3 Networks Define the Work Flow

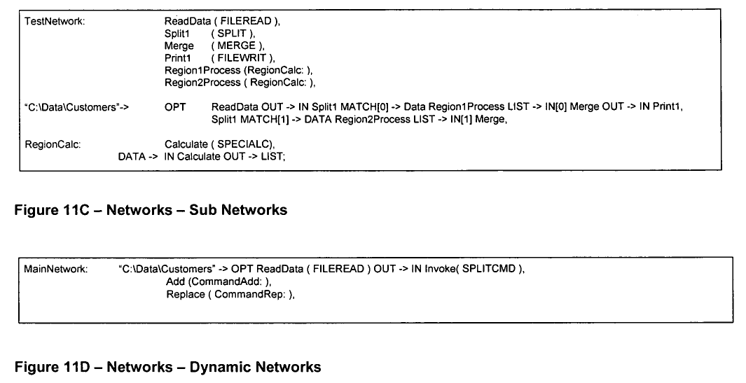

Network diagrams, how they are written, and how they may be nested are described in FIG. 11A-D and discussed in more detail at that point.

The network contains the logical layer header for all processes and functions defined within that network. It also contains a list of Message Libraries defined at the network level, and a list of load libraries (DLLs for Windows version) defined within the network.

A significant part of the NETWORK control block is a list of INPORT and OUTPORT controls. These ports are specified in the network diagram and are referenced in the calling network. IPs may be sent to these input ports, and received from these output ports. The network diagram logically connects the external network port name to a real input port of a contained process.

1.4.3.4 Ports provide Information Packet Linkage between Processes

Referring to FIG. 2C, each process, when created, defines only the name of a port and how to receive data (inport) or send data (outport). This feature is how each process can be created and tested independently from all other processes in the network. It also permits a process to be used in many different circumstances without change or the linkage be dynamically modified by an outside service. The dotted lines between control blocks are linkage only by defined name and are “hardened” after the open completes

A network diagram may specify “Process1 OUT->IN Process2” signifying that all IPs sent to OUT by Process1 are to appear as input IPs on the IN port for Process2. $NET-BUILD will:
Create an OUTPORT block and associate it with Process1, naming the port as “OUT”.
Create a DESTINATION block as a staging area for IPs that will be sent
Create an INPORT for Process2, naming the port as “IN” and connect it to the DESTINATION
previously built. Note: Multiple output ports may pass data to the same input port. The DESTINATION is the logical connector between the ports which are owned by the respective processes.

Port services use these control blocks to suspend and resume the processes as necessary according to queue size rules established or defaulted in the associated network.

Data for the input port PREFIX is not coming from another process; rather it has been defined in the network as a character string. An inport named “PREFIX” is created and marked as containing a single piece of information. End of Stream will be signaled after that record has been read, and the data block released.

1.4.3.5 Information Packets (IPs)

Data transferred between processes are contained within IP controls. Each IP contains:
Ownership linkage off of the owning process. Port services will transfer ownership as the IP travels through the network(s).
Queuing linkage with a header
   Within the owning process for IPs that are NOT on a port. i.e. being created or already received from another process
   Assigned to the DESTINATION block when just sent
   Assigned to the INPORT block when pending receive
A binary field (C++LONG or equivalent) available to the user for any purpose
An 8 character field available to the user for any purpose. Some services define several meanings for this field:
   “(”—Referred to as an open bracket. This signals the start of a logical data grouping.
   “)”—Referred to as a closing bracket. This signals the end of a logical data grouping started with the opening bracket. Brackets may be nested.
   Any other string available to the user for any purpose
The address of any storage area the user wishes to pass between processes and a field containing the current size of that storage area.
A flag defining the above storage area as being owned by the user, or owned by the supervisor. Storage owned by the supervisor will be maintained after the IP is returned and made available in a pool of like sized IPs.

The structure of the IP is system defined; the content may be whatever the user wishes. This invention may pass the IP between distributed systems or compress and group it into storage areas when capacity deadlocks occur. The IP is the only control which ports will process.

Referring to FIG. 2D, there are two examples of IPs. The top example is a chained string of four IPs each containing a record of data, as may be read from a file. Each IP has a size of 80, a pointer to a data record, and a blank flag.

The second example is ONE IP in which the data points to a tree structure. Each entry has a pointer to the first IP at that level, a pointer to the next branch at the same level, and a pointer to the first branch at a lower level. There are actually 9 IPs and 9 data areas in the sample, the one passed between ports and the eight IPs and respective data pointed to by the tree structure.

1.4.3.6 Message Library

This invention contains a message service which uses message skeleton definitions which are contained with libraries. Message libraries may be defined at the process level, the network level, the application level (“standard messages”) or at the system level (“Supervisor Messages”). Each level may also have multiple language versions.

The Message Library controls are maintained in a hierarchy for quick reference.

1.4.3.7 Content Management

The present invention refers to its components by name within a network; a method exists to locate and map all named services within the libraries referenced. Each library may contain multiple processes or function services, and up to one message library.

Referring to FIG. 2E, each loading of a network detects any reference to a library. The master network ($NETWORK) is loaded by the system and contains a reference to “Filter1” as the system library.

The system network is scanned, as loaded, detecting the name of the Filter1 library. Finding a new name (Filter1) the scan process builds a “LibraryReference” control (1) for Filter1. The build of each LibraryReference looks for a previous content description of Filter1 populating the details pointer. As this is the first reference to Filter1 a new library description will be created (2).

Each unique library is loaded into the system and scanned for content. Every process name located (3) is hashed and loaded into a ProcessHash index in this library description.

Subsequent networks loaded, during scanning the user supplied controls or as a dynamic library is loaded, will follow the same operation (6). Three types of content are recognized:
1. Each “Process” name located is added to the ProcessHash table (7).
2. Each “Function” name located is added to the FunctionHash table (8).
3. A message library, one only if found, is executed. Each contained message definition will insert an entry into a MessageHash table owned by each network (4, 9)

Upon load completion, each network in the system will be linked in a hierarchy and each network will have fast access to a list of processes, functions, and messages defined at that level.

During network execution processes are initially dispatched. Those process that contain localized message definitions, when executed, will add those unique messages off the process control (10).

This hierarchy of messages is referenced by the message service as required.

1.4.4 Services in the Performance Supervisor

Referring to FIG. 3, this illustrates how various supervisor services combine to meet two of the prime achievements of this supervisor:
Offer services to have every process run as efficiently as possible
Prevent processes from blocking; rather permit the processor to service other ready processes in the invocation.

1.4.4.1 The Dispatcher

There is only one operating system WAIT in the mainline code; that is in the GetNext subroutine of the dispatcher. That wait is entered when there are no processes ready to run. This is normally waiting for I/O to complete or a monitored directory to receive a file.

Each process is a self-contained mini application. Its connection to the system is primarily through input and output ports, secondarily through physical I/O operations. In programming terms it is a method of the PROCESS class. It maintains its own programming stack and may call services of this invention or services of the host operating system. In Intel based windows terms, it maintains its own ESP and EBP registers which form the call stack, and error stack.

As noted above, the StartReady service will locate any processes, in a newly introduced network, which are ready to run and place them on the ready queue for the next dispatcher looking for work. The rules for initial ready processes are:
One or more input ports have data ready. This may be from an IIP which is made ready when the network starts, or the network has an external port, with ready data, connected to an internal process.
The process has no input ports.

The dispatcher will locate the top entry on the ready queue and will prepare to pass it control on that processor. The ready process may be in one of two states:
Flagged as INITIAL status. The dispatcher must prepare the physical layer for execution by allocating a storage area for the program stack, ensuring the entry point address has been loaded and loading it if not. Other operational registers are set. Just before branching to the process the dispatcher saves its own operational registers in a storage area directly associated with the running dispatcher thread. By loading the newly established process registers it effectively enters the first instruction of the process.
Flagged as RESUME. The dispatcher has previously established the physical layer so the registers at time of SUSPEND have been saved. The dispatcher loads the saved registers and effectively re-enters the process at the instruction after the SUSPEND.

In either case the process begins/continues execution within its own miniature environment, which it will maintain for its life. It is important to note that the PROCESS never directly calls the dispatcher. All SUSPEND requests come from the performance supervisor. The process, without significant programming, will never know it was suspended and resumed. The closest the process comes to calling the dispatcher is when it returns at its own end-of-job, by returning from its highest level. The dispatcher recognizes this and enters TERMINATE processing.

At termination the dispatcher will free the programming stack, and will free any left over control blocks that the process should have released before returning. The dispatcher will log a message for owned resources that should have been released. After clean-up the process will appear as if it were never dispatched. This permits a process to be restarted as INITIAL at a later time.

The other dispatcher service is the SUSPEND request. This is made by other supervisor services when they determine the process must wait for some outside event. Sample conditions are:
An input port is empty and the process attempts a RECEIVE without an EVENT, covered later. Since no data is available the process cannot continue; port services initiates a SUSPEND. When data eventually comes into that input port, the port services processing the SEND request can see the receiving port is suspended and will initiate a RESUME. Resume will ENQUEUE the process on the ready queue where it will, when selected by the dispatcher, complete the RESUME. The process will not know there wasn't data ready. It will just receive the data it requested.
The process requests a block of data from a physical file, again without an EVENT. The request will go to I/O Services, which will start the request. In many cases the data will not be immediately ready so the I/O service will SUSPEND the process. Eventually the I/O will complete at which time the I/O Service will RESUME the process. The calling process again will not know it was suspended; only that its requested data is available.

This description has been for a single dispatcher. In multiple processor hardware systems, real or simulated through “hyper-threading”, there will be multiple dispatchers; each will select the next ready process and give it control, or go idle. It will remain idle until a dispatched process does something to ENQUEUE another process which will wake up the sleeping dispatcher(s).

1.4.4.2 I/O Services

The object again is to prevent the process from blocking and to operate in the most efficient manner. To achieve this in the area of I/O operations, all I/O services are located inside this inventions performance supervisor. Five basic services are offered; these are:

1.4.4.2.1 Open

Before any service can be performed on a file an environment must be established. The process will issue an OPEN request specifying, at minimum, a filename to process. Additional options may be specified overriding defaults.

Open will create an IOCONTROL class. This class is the root of I/O supervisor methods. The user will see a NULL class upon which he may issue a READ, WRITE, SEEK, CHECK, or CLOSE.

Open will check the filename, parameters, main storage capacity, and operating system capabilities. It will prepare the class for future calls. It may, for example with a temporary file, prepare for entirely in-storage operations with a system paging area backed file.

1.4.4.2.2 Close

Close will break down the class(s) built by open. It will ensure all buffers are flushed and returned.

1.4.4.2.3 Read

The process will issue a READ request to obtain data from the file represented by the IOCONTROL. Data will be returned (no event specified or data is immediately available), an event-set condition and no data (event specified and I/O has not ended), or an error condition signaled such as end-of-file. The process will not know if it was suspended during the read. Normally the user will opt for overlapped I/O and defer SUSPEND by specifying an EVENT to be checked later.

The read service will perform many functions:
Determine if the user already has an IOBUFFER for this request and if not, create one. A maximum of four concurrent buffers are permitted in the present implementation,
Specify the starting file offset and length of data to read into the buffer
Queue the request to the appropriate file manager, synchronous or asynchronous modes are covered later
Set an event for future checking (event requested on the read)
Return to the calling process for overlapped execution, or with data.
With no event specified and no ready data, read will issue a dispatcher SUSPEND request. The dispatcher will RESUME at a later time when the function will return to the caller.

The read request may service data from a physical file, from a file on a distributed connection, from in-storage temporary files, or from a pipe connection. Whatever the source, the calling process will have the same call. This permits a single process to read data from multiple sources without code change, enhancing re-use.

1.4.4.2.4 Write

Write, in most cases, is the same as read, only data is moving between the process and an external file.

One major difference is in buffer handling. If the user selects “locate mode” operation; a write call is made requesting an IOBUFFER. The returned buffer is then available to the process for filling and later processing by a subsequent write for the IOBUFFER. Locate mode eliminates multiple buffering and moving data between them.

If “Virtual Buffers” are requested, explained in a later figure, the data will go directly from the user buffer to the target device without any cache or operating system buffers.

Write requests, with an event specified that is checked later, offer significant overlap of processing and the writing of the data. Up to four buffers may be filled and “written” before a check is needed. Frequently by then the first operation has completed and there is no SUSPEND.

When write is specified without an event, and the I/O operation does not complete immediately, write will request a dispatcher SUSPEND. I/O completion will issue a RESUME to ENQUEUE the process on the ready queue for future dispatch. This is again transparent to the requesting process.

1.4.4.2.5 Seek

This request will reset the offset/address of the next operation. A subsequent read or write will be performed at the requested offset within the file. This operation will never suspend

1.4.4.2.6 Check

Event and check enable maximum operational overlap within the calling process.

Check will SUSPEND when:
The IOBUFFER I/O operation has not completed, AND
The check call requested a wait (the default). Check may optionally return with a “not complete % condition so the process may perform other work and check again later. AND
The check call did not specify an event. An event, if specified, will be posted when the operation completes and is the input to wait and waitlist service calls. If specified and not complete, check will return with “event set” code indicating a wait may be issued.

Check will end when:
The I/O completes
The I/O supervisor calls the dispatcher ENQUEUE service
The process pops to the ready queue top
A dispatcher resumes operation and control returns to check, then back to the calling process.

1.4.4.3 Port Services

As previously described, the connection between processes is through an Output Port—Destination—Input Port grouping of classes. The Port Services part of this invention handles the transfer of IP data packets between processes. It also enforces capacity rules so no port may be flooded with IPs. The process aware services relating to ports are OPEN, RECEIVE, SEND, and CLOSE.

1.4.4.3.1 Open

A process is compiled knowing only the NAME of a port. A network definition will determine which ports of one process are connected to another. This preserves the process as a “black box” component.

The network invocation will create input port classes and chain them off the associated process. Similarly it will create output port classes and chain them off their associated processes and will create destination classes which join the appropriate input and output port classes.

Open is issued by the process specifying:
Whether this is an INPUT or OUTPUT port. Lets open know which chain to search for the name
The name of the port to be opened. Open will scan the chain for a matching name.
The array number of the port to be opened. This invention will support an array of ports with the same name. Present implementation limits the array size to 20 ports. Normal operation, when the array index is not specified, is to open array entry 0.

The connection between one process output port and another process input port is made in two parts:
The sending process to its outport
The receiving process to its inport.

Both connections are NOT required for either process to function. IPs may be sent to an open output port and will be queued until the downstream process opens its matching inport. Likewise a process may request data from its inport before the upstream process opens its matching outport. In this case the requesting process will see a no data ready condition described below.

1.4.4.3.2 Receive

Receive transfers IPs from the specified inport to the calling process. There are several options on the receive request including:
Read a single IP populating the FirstIP location
Read up to a supplied count of IPs populating the FirstIP and LastIP locations. The received IPs are linked together and the LastIP link field is null. The requested count is changed to the number of IPs actually returned
Read may:
   Request to be suspended if no data exists or
   To never suspend and return with null variables and count.

Auto-suspend is the default where receive will suspend when no data is available.
Read may specify an event to be posted when data becomes available. This is covered more in an event processing figure.

Receive will inspect the input port for data availability. When no data is available:
Suspend is requested or defaulted—receive will set a flag in the inport as a signal to the upstream SEND service then call the dispatcher SUSPEND service. The process will be suspended until data is available. The dispatcher will RESUME operation at the following instruction and receive will continue as if it were never interrupted.
Suspend is NOT requested—receive will return to the caller with an error code. Depending on whether an event is specified the return code will be NO DATA AVAILABLE or EVENT SET.

In either case, i.e. data was available or data was not available and is now available, receive begins processing the queue. Processing typically includes:
Scanning the DESTINATION blocks for data that has not been merged into the input port data queue. Note that there may be several output ports feeding a single input port. In this case all data from the first destination block will be processed followed by each subsequent destination block containing data. There can be no guaranteed order of IPs coming from multiple sources other than the data from each upstream port will be maintained in the same sequence.
Removing the top IP on the input port populating the user FirstIP variable.
Counting off the requested IPs, unless the request count is greater than the current queue size when all the IPs will be removed.
Populate the LastIP variable if supplied. If not supplied there will only be one IP removed.
Reduce the count of IPs remaining on the input port data queue.
Check the flag set by the upstream send operation. If set and the new count is below the queue capacity, issue the dispatcher ENQUEUE service to RESUME the upstream process. It was suspended on output port capacity and may now continue.
Update the Count variable if supplied with the number of IPs supplied.
Return to the calling process with data. Again the calling process will not know if it was suspended on an empty input queue.

A special use of receive is to specify no suspend and a count of zero. The calling process can inspect the return codes to determine if it would suspend if it actually requested data.

1.4.4.3.3 Send

Send transfers IPs to the specified outport of the calling process. There are several options on the send request including:
Send a single IP from the FirstIP location
Send up to a supplied count of IPs starting at the FirstIP and ending at the LastIP locations. The sent IPs are linked together with the LastIP link field null. The supplied count is changed to the number of IPs that were not sent. When the number of IPs supplied exceeds either the count or the number that may be processed without suspending, the FirstIP variable is updated to the next UNSENT IP. LastIP remains unchanged. It is possible to return with the same IPs and count as called if no suspend and the output queue is at capacity.
Send asks to be suspended if the target port has reached capacity and the suspend flag is set to Suspend or to Auto-suspend. Auto-suspend is the default where send will suspend when the output queue is full, or return otherwise.
Send may specify an event to be posted when the port is no longer at capacity. This is covered more in an event processing figure.

Send will inspect the output port for queue capacity. When no room is available:
Suspend is requested or defaulted—send will set a flag in the outport as a signal to the downstream RECEIVE service then call the dispatcher SUSPEND service. The process will be suspended until data is removed from the queue and the port is below capacity. The dispatcher will RESUME operation at the following instruction and send will continue as if it were never interrupted.
Suspend is NOT requested—send will return to the caller with an error code and no IPs removed from the chain. Depending on whether an event is specified the return code will be AT CAPACITY or EVENT SET.

In either case, i.e. data was available or queue was at capacity and is now available, send begins processing the queue. Processing typically includes:
Locating the DESTINATION blocks for data from this output port.
Chaining the IP from the user FirstIP variable.
Counting off the supplied IPs, unless the supplied count is less than capacity minus the current queue count, when all the IPs will be removed.
Update the FirstIP variable with either NULL or the next IP that was not used.
Increment the count of IPs put on the DESTINATION data queue.
Updating the supplied Count variable with the number of IPs NOT processed. When the count is zero, set the LastIP variable to NULL
Check the flag set by the downstream receive operation. If set and IPs were placed into the DESTINATION, issue the dispatcher ENQUEUE service to RESUME the downstream process; it was suspended on an empty input port and may now continue.
Return to the calling process with new variables. Again the calling process will not know if it was suspended on an output queue at capacity condition.

A special use of send is to specify no suspend and a count of zero. The calling process can inspect the return codes to determine if it would suspend if it actually sent data. LIMIT is a preferred method to determine current queue condition.

1.4.4.3.4 Limit

This service will determine the number of IPs that may be sent until the capacity is reached. If specified at open it will return the maximum capacity, a number that may be used to efficiently fill the queue.

When used after a send it will return how many additional IPs may be sent without suspending.

1.4.4.4 Event Services

The services are fairly simple; how they are integrated into the performance supervisor significantly improve performance. There are several parts to be discussed including the event class, Event Set, Event Post, Wait, and WaitList.

1.4.4.4.1 Event class

An event is a simple class with nothing visible to the using process. It contains a post code field which the user may interrogate with a Status service or set with a Post service.

The event is used extensively with other services to achieve maximum overlap of operations. It may also be used as synchronization between processes. i.e. An IP may carry an event between processes. Some uses include:
I/O Service Read, when specified with an event, will POST the event when the data has been read. It is used at the buffer level so four events may be used, one for each buffer. A process may issue a WAIT on a single event or, more likely, create an EVENTLIST containing events from READ, WRITE, multiple InPort RECEIVE ports and multiple OutPort SEND ports. WAIT will return when any of these events are posted, identifying the first posted event in the list. Processing may be directed to handling that event, returning to WAIT for the next event to complete.
I/O Service Write, when specified with an event, will POST the event when the data has been written and the buffer is again available for filling. Again up to four buffers may be active, each with an EVENT. The example shown above is again valid.
Port Service Receive, when specified with an event, will POST the event when the input port receives data.
Port Service Send, when specified with an event, will POST the event when the output port is no longer at capacity.
A user may POST or WAIT on an event from itself or from another process. It must know the event address before issuing the WAIT or POST and will most likely receive/send this information within an IP.
Functions communicate with the Host Process (starting a function request) and with the caller when a request completes.
Turbo Exit posts the exit completion event at End-of-File. The host process performs cleanup and terminates.

The following services act upon one or more events.

1.4.4.4.2 Post

Post will mark an event as complete, and store the user supplied post code into the event. The default post code is a numeric 64. The post code may be used to signal some special handling.

Post most often is acting upon an event owned by a different process. For example when sending to an outport the target inport may have an event specified by the target process. When the event is marked as waiting, the target process will be in suspended state. Post will issue a DISPATCHER ENQUEUE for the target process and continue. The target process will now be ready to continue, and on a multi-processor system may start operation while the sending process continues operation.

It is likely, in this scenario, for both the sending and receiving processes to continue for some time, each sending and receiving data simultaneously.

1.4.4.4.3 Wait

Wait will inspect the event for a post code and when not set calls the DISPATCHER SUSPEND service. The dispatcher not return until POST has been executed against the event.

Wait will return to the caller with the enclosed post code when it is initially set or set during suspend.

1.4.4.4.4 Clear

Once used an event must be cleared before being reused. Without the Clear service a subsequent WAIT against an event will return immediately with the old post code.

1.4.4.4.5 Status

An event may be queried for the current post code. This is useful to determine if an event is already posted without risking suspend.

1.4.4.4.6 EventList

Multiple events may be active such as four events each associated with an IOBUFFER. An EVENTLIST class may be established which contains an array of EVENT classes used in different ways. ReadFile, for example, has four IOBUFFER events as described above, an EVENT from a PORT, and a user EVENT. The WAITLIST service will act against a list as the WAIT service acts upon a single EVENT.

1.4.4.4.7 WaitList

The Event Processing service may be requested to wait on a list of events. It may be instructed to return when any one of the events are posted or when a specific number of events, up to the number in the list, are posted.

WaitList will SUSPEND the calling process when less than the requested number of events is posted. Normally 1 of n is specified.

POST will determine if a list is active on the receiving process and will issue the DISPATCHER ENQUEUE only when the number of events is satisfied.

1.4.4.5 A Sample Flow

Still referring to FIG. 3, the lower box represents the flow in a single process; the sample FILEREAD process is demonstrated. The numbers used in this section refer to the numbers found on the arrows.

The network startup process has called the DISPATCHER StartReady service. It found the FileRead process with a predefined IIP for the “OPT” input port. This satisfied the ready-to-run requirements and placed the process on the ready queue.

The dispatcher found this process and determined that is was an INITIAL dispatch. The dispatcher established the program stack, other controls, and registers. Dispatch Initial passed control to the entry point of FileRead (1).

FileRead performed simple initialization and proceeded to OPEN INPORT OPT [0] (2). This service call went to the Port Processing service open where it located OPT array 0 on its inport list of defined ports. The user InPort was initialized and (2) control returned to the process. No suspends are possible at this time.

FileRead needs to know what file to read and other control information. This information is found in the OPT port IP. It issues a RECEIVE against the OPT port (3), going back to the Port Processing service where it finds the IIP that was defined in the network. Completing the FirstIP variable with the address of the IP it returns (3) to the calling FileRead process. Since the IP was already defined it again does not suspend.

FileRead now knows the name of the file to read. It issues an OPEN (4), requesting an IOCONTROL. This request goes to the I/O Supervisor where the file is located. Inspecting the attributes of the file and the attributes of the file system and operating system it determines the optimum processing methods for the file. It creates an IOCONTROL and updates the contents with the current status and returns to FileRead (4) with the address of the IOCONTROL.

FileRead is now ready to read the first data. It allocates, in this example based on the file size, two IOBUFFER controls then issues a read against the first IOBUFFER (5). In this example events are not used. The Read I/O Service queues the request and finds that data is not immediately available. Since no events were specified, READ goes to Dispatcher Suspend (6) and this process execution is suspended.

The I/O operation eventually ends and the I/O service finds the requesting process has been suspended on this I/O operation. It issues the DISPATCHER ENQUEUE service which places FileRead back on the ready queue.

The same, or a different dispatcher thread, selects FileRead from the ready queue and, since it is not the initial call this time, reloads the suspended registers and continues execution (7). Execution resumes inside the I/O Service Read function where the read status information updates the variables passed in the original READ request, such as data read, final status, and data address. Control is returned (8) to FileRead.

FileRead starts preparing the data for sending out the OUT port. It finds the port has not been opened so (9) calls Port Supervisor Open service to prepare the output port named OUT, array 0. Open locates the network defined OUT[0] port and creates a connected OUTPORT class. It then (9) returns to FileRead with the OUTPORT class.

FileRead now has data and an OUTPORT ready to take the data. It scans out some text lines and creates IPs to hold part of the buffer data. It issues a SEND request (10) to the OUT port.

Port Supervisor, Send service transfers all the IPs to the downstream port. By design, the name of the downstream port is not important to the operation of FileRead. FileRead operates within its own “black box” and just sends data out its OUT port. The send service does NOT FILL the downstream port to capacity so returns immediately (10) to FileRead. All IPs have been removed from the SEND request.

FileRead still has data remaining in the read IOBUFFER so builds more IPs and populates them with data. (At this point the REAL FileRead will not do this operation as it very closely tracks the number of IPs the target port will accept using the LIMIT service, and also uses multiple events to trace the file read operation, the OPT port status, and the OUT port status). For demonstration purposes we continue.

FileRead (11) issues a SEND request to the OUT port for more IPs than the port can handle. Without an event specified and requesting automatic suspend, the SEND service prepares all the IPs that the downstream port can handle until capacity is reached. Since there are still IPs in the request, the Port Processing Send service marks the downstream InPort with a flag and (12) calls the DISPATCHER SUSPEND service and the FileRead process suspends.

FileRead remains suspended until the downstream process issues a RECEIVE against its InPort. RECEIVE detects the flag and that the count is now below capacity; it issues the DISPATCHER ENQUEUE service to make FileRead ready again.

The same, or a different dispatcher thread, finds FileRead at the top of the ready queue and again goes to DISPATCHER RESUME where control is passed back to SEND (13) where it left off. SEND again validates how many IPs it can handle and moves them over to the downstream InPort. If it again exceeds capacity the above process loops until all sent IPs have been assigned to the downstream InPort.

Send (14) returns to FileRead where it can again request the IOBUFFER to be refilled. This will loop back to (5) and continue until end-of-file is signaled on the I/O Service Read request.

FileRead will send an I/O service CLOSE request to complete I/O services, and issue a CLOSE to the OUT output port. It will also CLOSE the OPT input port, release any memory obtained at initialization, and issue the last return statement.

Return will go up the program stack and return to the DISPATCHER in the TERMINATE mode. The dispatcher will free the program stack allocated at INITIAL (1), wait for all IPs in transit to be transferred to the downstream process, wait for any messages to complete, clean up any remaining control blocks and reset the process to uninitialized.

It is possible for a process to be restarted once ended. This is normally only in dynamic networks. In any case the FileRead process is now ready to start at Initialize (1) if called again.

1.4.4.6 Run what is ready

This example has demonstrated how a process does not directly call the dispatcher yet is suspended and resumed frequently as data reads complete, and as data being sent to a downstream port reaches capacity and is relieved. The code of the process does not concern itself with any waits, capacity, or where its ports are connected. It does its function of reading data from a file and making IPs from that data.

Indicated, but not directly, are the downstream processes running concurrently with FileRead. The supervisor will run everything that it can and will only block when no work is available. In this example it will only block waiting for physical file I/O.

1.4.4.7 Blocking vs. Suspend

FileRead does not block. If it were to do its own I/O, it is possible but not recommended, then it would block when the file data was not available. During this period THE ENTIRE DISPATCHER thread would block and could not handle the downstream processes. On a single processor system the entire application would wait although the operating system could reallocate the CPU to another unrelated application. Operating system dispatching is outside the discussion of this invention.

1.4.4.8 Concurrency

Suspend from the Performance Supervisor will save the FileRead process's execution time registers into the PROCESSORCONTROL control block and locate another process that is ready to run. The time FileRead spends waiting has no impact on the operation of other processes within the application. In the single processor example above, the process receiving the IPs will be able to run while FileRead is waiting for more data. Significant performance improvement through avoiding idle time is achieved.

As more processes are defined in the network, more opportunities for concurrent operations are found. A single processor cannot truly have concurrency as it can only be dispatched to one process at a time. Avoiding that processor from blocking means it can perform other work where otherwise it would be idle, wasting system resources.

1.4.5 The I/O Supervisor

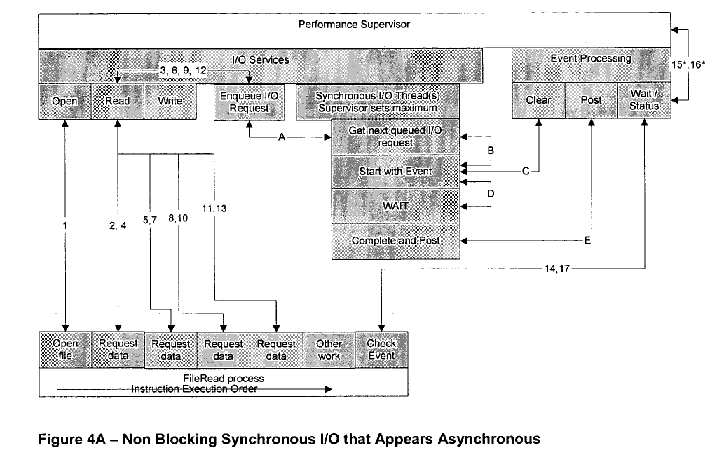

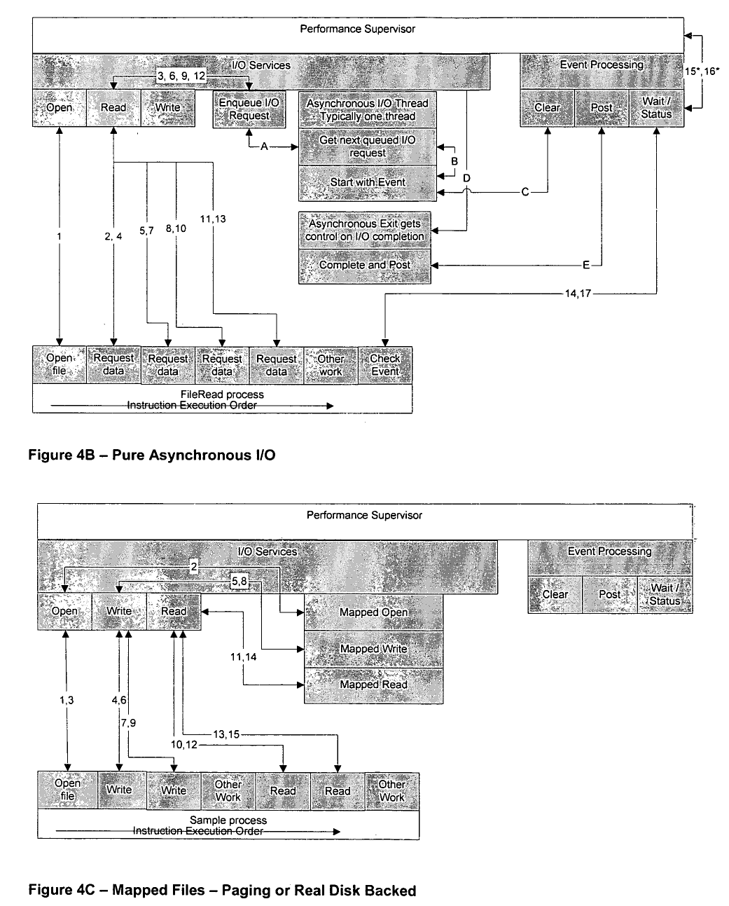

FIG. 4A-C depicts three paths the I/O Supervisor may take to service a user request. The choice of method is highly operating system dependant.

1.4.6 Open

The process will issue an open request specifying a file name (1) on all three figures. This step is on all three methods because it is the open process which determines the most efficient method on this host system. The choices are:

Memory Mapped File: This mode is selected for any file that is opened with a maximum concurrent I/O specified as INFINITE (−1) and the file name specified for read or write starts with the special character ‘%’.

Asynchronous I/O: This mode is the most efficient but cannot be run on all systems. Open checks the following items; all must be available before selecting this mode:
The local system operating system must support asynchronous I/O:
   The operating system Platform ID must be acceptable. For example Windows 98 and earlier versions cannot run asynchronous I/O. Windows NT, 2000 and XP are capable.
   The file system upon which the file resides must be acceptable. For example FAT and FAT32 systems cannot run asynchronous I/O; the HTFS file system is capable.
The file itself cannot be compressed. Read file attributes are checked for this condition. Files opened for write cannot be requesting compressed.

The IOCONTROL, for files that pass these tests, is marked as asynchronous ready. Open will ensure at least one asynchronous I/O thread is available and will start the first one if not.

Synchronous I/O: This mode is chosen when no more efficient method is available. Open will ensure at least one synchronous I/O thread is available and will start the first one if not.

InLine: Some operating systems do not support threading at all. DOS and Windows 3.1 are examples. These operating systems must run I/O within the calling thread. Overlapped operations on these systems cannot happen so I/O requests will be serviced when issued and the process (and this invention subsystem) will block on all I/O requests that require time to complete. This method is very seldom used.

This invention may have a combination of all methods active in the same invocation (except inline) as there may be temporary files (running memory mapped), compressed files (running synchronous), and normal files (running asynchronous). Open chooses the best method for each open request.

OPEN checks each request for special handling. For example, a request for no-buffering mode will be honored. VIRTUAL_IO is also checked and honored. This mode is available in both synchronous and asynchronous mode and is covered in a later figure.

For all modes, the READ, WRITE, SEEK, and CHECK services enter the same I/O supervisor

1.4.6.1 Synchronous I/O

FIG. 4A describes the flow of I/O requests for Synchronous operations. The FileRead example is used as a sample process requesting I/O services.

FileRead initialization will create some IOBUFFERS for potential read requests. The same control blocks will be used for the life of the process. They may have buffer space allocated with a pointer in the block, or if left null the I/O supervisor will obtain the data area.

The FileRead process issues a read request for data (2) which enters the I/O supervisor where validity checks are made and, when required, buffers allocated. The IOBUFFER fields are modified to reflect this request then the control is enqueued (3) on the Synchronous IO NewWork header.

Thread-safe techniques are used to push this entry down on the queue because there may be many truly concurrent processes initiating I/O activities, i.e. multiple threads running on multiple hardware processors. The SyncIONewWorkEvent event is waited on by the synchronous I/O threads when they go idle. The read service will set this event waking any sleeping threads. The read service now returns to the calling process (4) to continue operation. There are no blocking or suspends in this flow and the calling process continues to the next operation.

FileRead has 4 buffers to fill. It repeats the operation (5, 6, 7) for the second buffer then (8, 9, 10) for the third buffer and finally (11, 12, 13). FileRead at this time has initiated 4 overlapping read operations. It continues to do other work until the data is needed.

FileRead issues a CHECK (14) against the first buffer. Check has the capability to SUSPEND the calling FileRead process until the I/O operation is complete, or when data is ready, will return immediately. The calling process will not know if it was suspended.

When the I/O supervisor has not completed the I/O operation CHECK will call the DISPATCHER SUSPEND (15) which will stop servicing FileRead and find another process to run. Eventually the I/O will complete and POST the event (E). POST will DISPATCHER ENQUEUE the FileRead process. The same, or a different dispatcher thread, will find FileRead as the next ready process and DISPATCHER RESUME the process. It will return to WAIT (16), return to CHECK, and then return to FileRead (17).

This dispatcher thread runs (may run) concurrently with the synchronous I/O Supervisor worker thread. Timing is dependant on the operating system dispatcher not this invention. Interlocks are designed for operations to complete in any order or even concurrently.

The synchronous I/O thread when:
a) In IDLE state, will be woken when the SyncIONewWorkEvent event is set, or
b) In ACTIVE state and completes a previous request

Will call the SyncIOGetWork routine. This routine will return the next highest priority I/O request pending, or return null when no work is available. The thread-safe new work queue holds new requests in reverse chronological order. They are rearranged in priority chronological order.

SyncIOGetWork will temporarily lock out all other synchronous I/O threads while it rearranges the queue. A thread-safe remove ALL new work request (A) is made as the processes are all still running and may be requesting new I/O at any time. The pending new work, if any, will be ordered by calling process priority then in chronological order within that priority.

The resulting chain, if any, will be merged with any requests still pending on the SyncIOQueued queue. The top entry is returned to the synchronous I/O thread (B) as the next operation to initiate. If a null is returned, signifying no work exists, the thread will go idle waiting on the new work event.

The top request may be for a read as in this case, or for a write. Until this point in processing there is no difference. The synchronous I/O thread will start the I/O operation and may:
a) Receive an immediate end indication. Data ready in the cache or end-of-file conditions will typically return immediately. When this happens any wait is bypassed
b) Receive an I/O Pending indication. The thread will BLOCK on the request and wait for the operating system to complete the I/O request and UNBLOCK the thread.

In synchronous I/O processing the calling thread is blocked by the operating system. The Synchronous I/O supervisor is designed to start many worker threads, one for every I/O request up to a performance limit where it is better to not start a request than have another concurrent I/O operation on the system. The Performance Supervisor Dispatcher makes the decision on starting a new thread when it finds the master threads going idle. If another Synchronous I/O thread will keep the system running then it starts another. Blocking an I/O worker thread has no impact on the DISPATCHER threads; they continue to service processes while work is available.

When the I/O operation completes, whether immediate or delayed, the buffer is posted complete (E) and the CHECK operation, if waiting, is resumed (16).

The multiple blocking synchronous I/O threads make the I/O subsystem appear as highly overlapped and asynchronous, even though it is not. The host operating system may not support asynchronous I/O and may not support overlapped I/O. This supervisor will simulate this operation even though it is not available.

1.4.6.2 Asynchronous I/O

FIG. 4B describes the flow of I/O requests for Asynchronous operations. The FileRead example is used as a sample process requesting I/O services and is the exact same process as in FIG. 4A above.

The flow for Synchronous and Asynchronous IO preparation is identical except work is queued on the Asynchronous IO NewWork header and the AsyncIONewWorkEvent event is posted. The differences are in the Asynchronous I/O worker thread.

An I/O completion exit is enabled, it is given control by the operating system when an asynchronous I/O operation completes.

The asynchronous I/O thread when:
a) In IDLE state—and woken by the AsyncIONewWorkEvent event being set, or
b) In ACTIVE state—and a previous request is initiated

will call the AsyncIOGetWork routine. This routine will return the next highest priority I/O request pending, or return null when no work is available. The thread-safe new work queue holds new requests in reverse chronological order. They are rearranged in priority chronological order.

AsyncIOGetWork will temporarily lock out all other asynchronous I/O threads while it rearranges the queue. A thread-safe remove ALL new work request (A) is made as the processes are all still running and may be requesting new I/O at any time. The pending new work, if any, will be ordered by calling process priority then in chronological order within that priority.

The resulting chain, if any, will be merged with any requests still pending, the AsyncIOQueued queue. The top entry is returned to the asynchronous I/O thread (B) as the next operation to initiate. If a null is returned, signifying no work exists, the thread will go idle waiting on the new work event.

The top request may be for a read as in this case, or for a write. Until this point in processing there is no difference. The asynchronous I/O thread will start the I/O operation and may:
a) Receive an immediate end indication. Data ready in the cache or end-of-file conditions will typically return immediately. When this happens the buffer is posted complete.
b) Receive an I/O Pending indication. The thread will place the request on an active queue then look for more work.

In asynchronous I/O processing the calling thread does not block. The Asynchronous I/O supervisor starts one worker thread which has the capability of initiating many concurrent operations.

When a delayed I/O operation completes the operating system gives control to the exit routine (D) and points to the IOBUFFER that initiated the I/O. The exit will post the IOBUFFER (E) and wait for the next operation to end. The POST operation will call the DISPATCHER ENQUEUE service if it was waiting (15) and the CHECK operation, if waiting, is resumed (16).

One asynchronous I/O thread is more powerful than multiple synchronous I/O threads.

1.4.6.3 Mapped Files

FIG. 4C describes the flow of I/O requests for memory backed operations. An imaginative process called “Sample” is used for discussion purposes. A “cabinet file” creation process has used this technique replacing many heavily used real temporary files with in-memory temporary files showing significant performance improvement.

There is no physical I/O involved; potential suspends and inter-thread communications are eliminated.

“Sample” initialization will create some IOBUFFERS for potential write and read requests. The same control blocks will be used for the life of the process. They may have buffer space allocated with a pointer in the block, or if left null the I/O supervisor will obtain the data area. Using the system buffers will eliminate double buffering for even more efficiency. “Sample” then issues the open (1) specifying −1 concurrent operations and a filename starting with a “%” character. This combination triggers the Mapped Files mode of operation.

Open processing (2) will reserve large blocks of virtual memory but not allocate any pages until needed, saving real memory usage and potential paging activity. Control returns to “Sample” (3) with the IOCONTROL class address which will be used in future calls. Operation appears identical to “Sample” regardless of how open processed the request. The I/O supervisor may operate in Synchronous, Asynchronous, or Mapped Files modes without the calling process knowing.

The “Sample” process issues a write request for data (4) which enters the I/O supervisor where validity checks are made. Control is passed to the Mapped Write routine to service the request.

Mapped Write will allocate memory in page size blocks, enough to hold the data on this request and, a) if in locate mode return the address of the buffer for the process to fill or b) transfer the data into the virtual buffer. It returns to Write (5) which returns to “Sample” (6) completing the request.

“Sample” writes another block (7, 8, 9) operating the same as (5, 6, and 7). At no time did the process block or be suspended by the supervisor. After performing other work “Sample” needs to read some or all the data. It may issue a SEEK (not shown) to position the read point at any time. The Read (10) enters the I/O Supervisor branching to Mapped Read (11) for this I/O. The appropriate part of the data buffer is returned (11) and control passes back to “Sample” (12). The process is repeated for the next read operation (13, 14 and 15).

1.4.6.4 Virtual Buffers for I/O Performance

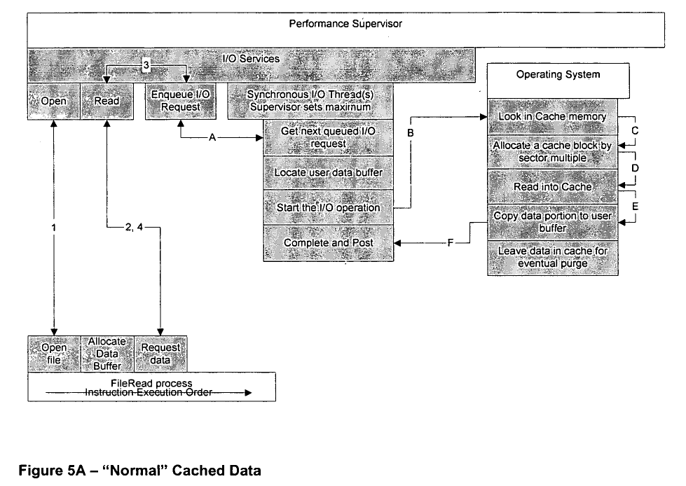

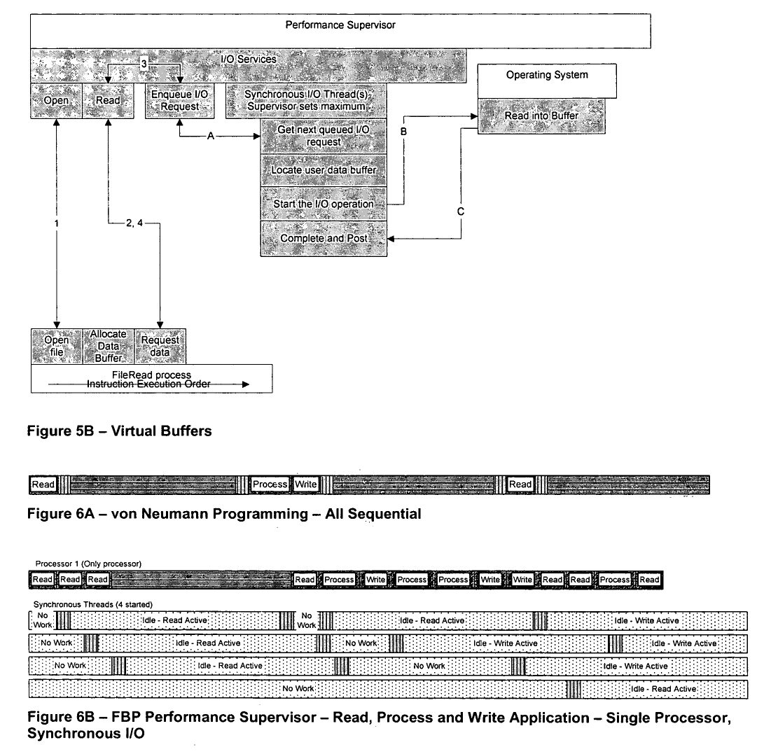

FIG. 5A-B depict both the advantages and disadvantages of using the operating system file cache mechanism. For small, frequently referenced files the advantage of a cache outweighs the system impact. For large seldom used files the cache can impact overall performance. This invention will default to either method depending on file size. An Open may specify it wants virtual buffers by requesting “NO_BUFFERING” as an option.

FIG. 5A shows a synchronous I/O thread being called. The process described will be the same for asynchronous I/O just the path to get to the operating system will differ. Steps (1, 2, 3, 4, and A) are the same for either operating mode.

The I/O thread will eventually “Start the I/O operation” (B) passing the request to the host operating system. First the operating system will look for the file already in its cache and, for this discussion, not find it there.

Physical I/O is performed, in sector multiples, to sector boundary allocated memory. Since the data is not in the cache, the operating system (C) will allocate a block of memory, read the data into that memory (D), copy a portion of the data into the user buffer (E) and complete the read by (F) unblocking the thread for Synchronous I/O or queuing the completion exit for Asynchronous I/O. Depending on the operating mode, data may be copied two to three times before making it back to the user.

Another request for data may repeat the process and find the data already buffered. This will result in immediate data being returned to the caller but most likely not all the requested data will be available and the read operation repeats.

FIG. 5B depicts the same operation, this time using “Virtual Buffers”. This mode requires the user to allocate memory on segment boundaries and request data in multiples of segment sizes. Failure to do so correctly will result in I/O failures and bad return codes.

The sample FileRead application actually chooses which mode by estimated file size. Files larger than 1 MB will request Virtual Buffers. FileRead will define large (64 MB) blocks of virtual storage and allocate pages as required.

Operation through the I/O Supervisor is the same as cached reads until the operating system (B) has to read data. It will not check the cache but initiate sector size reads directly into the user buffer. When the I/O completes it will signal the I/O Supervisor (C) completion which will mark the IOBUFFER complete, which will, if required, DISPATCH ENQUEUE the process to continue running.

FileRead will process the data returned and free the allocated pages as they are emptied. There are no memory pages left holding data, and through appropriate use of “free” the paging system will never have the overhead of handling never again referenced pages.

For large sequential reads or writes of data Virtual Buffers save significant processing overhead. The method is much more difficult than simple read/write operations but in this invention a single well written process can be leveraged many times. FileRead and FileWrite are examples of extensive programming inside a black box process extending its efficiencies to all callers.

1.4.7 Performance Effects

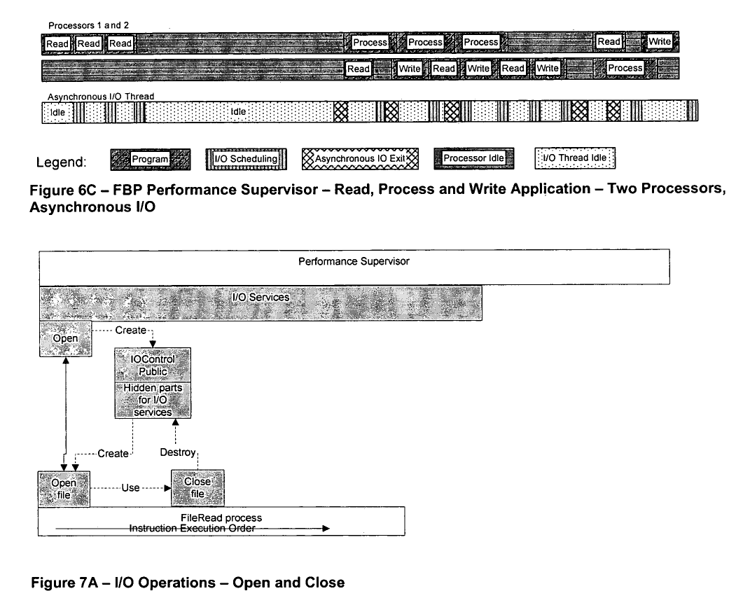

FIG. 6A-C compares three modes of operation for the same end; reading data, processing that data, and writing it to another file. The flows of conventional “von Neumann” (FIG. 6A), this invention running single processor and synchronous I/O (FIG. 6B), and this invention running multiple processor and asynchronous I/O (FIG. 6C) are shown for comparison.

The objective of this invention is to:
Perform more work
In less time
With a high degree of reuse.

These diagrams show the results.

1.4.7.1 von Neumann processing

FIG. 6A depicts the timing when performing a conventional read-process-write program.

The program will issue a READ which will initiate an I/O operation and block until the I/O completes. During this time the operating system may dispatch other applications or, most likely, will go idle.

Eventually the I/O completes and control returns to the application where it will process the data and initiate a write operation. Again control passes to I/O write which will block the application until it completes. This flow continues until the read eventually returns an end-of-file indication and the program terminates.

Significant time is spent waiting and little time is spent processing the data. As processor speeds increase at a rate faster than equivalent physical I/O operations, the processors will spend an increasing percentage of time waiting. They are most cost effective when actually executing user programs rather than waiting.

1.4.7.2 This Invention—Single Processor, Synchronous I/O

FIG. 6B depicts the LEAST efficient mode of this invention. It is shown to demonstrate that this invention can greatly improve performance on simple desktop machines running “user” level operating systems. For example, at this writing, MicroSoft Windows XP has two versions; the home edition which supports a single processor and is often deployed with FAT file systems, and the Windows XP Professional which supports dual processors and is often deployed with NTFS file systems.

The application has three processes for demonstration purposes are called “Read”, “Process”, and “Write” in keeping with the objectives of FBP. The “Read” will issue a read request which is queued to the first Synchronous I/O thread to come ready. Execution returns to the calling process; meanwhile the synchronous thread initiates the I/O request and blocks until I/O completion.

The “Read” process will issue another read, then another. At this time the process will have to wait for completion so issues a check (not shown) and suspends. “Processor 1” may service other processes if any are ready. It is significant to note that “Processor 1” does NOT block on the I/O but is available to dispatch other ready processes.

Eventually the first I/O completes, giving control back to the blocked synchronous I/O thread. This thread completes the I/O processing and posts the “Read” process. “Processor 1” comes out of idle and dispatches the “Read” process which empties the now full data buffer into IPs and sends them to the “Process” process. The send operation readies “Process” which is left on the dispatcher ready queue

“Read” on “Processor 1” now has an empty buffer so issues another read. The read returns immediately and “Read” suspends waiting for more data. The “Processor 1” dispatcher looks for more work and finds “Process” ready. “Process” gains control, receives the IPs created by “Read”, performs its calculations and sends the resulting IPs out. The “Write” process has been waiting for input so is placed on the dispatcher ready queue.

“Process” attempts to receive more input data, but since there is none, will suspend and the “Processor 1” dispatcher gives control to the “Write” process. “Write” will receive the IPs and initiate a write operation, waking the second synchronous I/O thread which handles the request. “Write” continues until it suspends on receive of more data.

Meanwhile the second I/O operation has ended and more data is available to the “Read” process. “Read” is dispatched and generates more IPs for the “Process” process.

The dispatcher will give control to whichever of the three processes, “Read”, “Process”, and “Write” are ready. This will happen until “Read” detects end-of-file and closes the output port. “Process” will detect the closed input port, complete operation and close its output port. Write will detect the closed input port and close the output file. When all processes have terminated, the application will clean-up and return to the operating system

This figure shows the present invention with significant overlap of processing and physical I/O. There is no blocking on the “Processor 1” dispatcher thread as the synchronous I/O threads will block in its place. More work is done in less elapsed time, with less processor overhead.

1.4.7.3 This Invention—Dual Processor, Asynchronous I/O

FIG. 6C depicts a MORE efficient mode of this invention. It is shown to demonstrate that this invention can greatly improve performance on either a single processor computer with hyper-threading or a server style computer with multiple processors each possibly with hyper-threading. Only two processors are shown but this may be extended to as many processors available on the computer. This computer is also using a file system that supports asynchronous I/O and is processing a non-compressed file which the current MicroSoft window operating systems can process in asynchronous mode,

The application is the same as depicted in FIGS. 6A-B. “Read” will issue a read request which is queued to the Asynchronous I/O thread. Execution will return to the calling process while the asynchronous thread initiates the I/O request.

The “Read” process will issue another read, then another. At this time the process will have to wait for completion so issues a check (not shown) and suspends. “Processor 1” may service other processes if any are ready. It is significant to note that the Processor does NOT block on the I/O but is available to dispatch other ready processes.

Eventually the first I/O completes giving control to the asynchronous I/O exit. This exit completes the I/O processing posting the “Read” process. Processor 2 dispatches the “Read” process which empties its data buffer into IPs sent to the “Process” process. The send operation readies the “Process” process that is immediately picked up by Processor 1, which has been idle since the earlier “Read” process suspended.

“Read” on processor 2 now has an empty buffer so issues another read. The read returns immediately and the process suspends waiting for more IO completions.

Simultaneously “Process” on processor 1 has created IPs and forwarded them on to the “Write” process. This has enqueued “Write” on the ready queue but since both processors are busy it remains on the queue pending dispatch. Once “Read” suspends, processor 2 will select the now ready “Write” process.

The second I/O operation has ended and more data is available so the “Read” process generates more IPs keeping the input port for “Process” with available data.

The dispatcher will give control to whichever of the three processes, “Read”, “Process”, and “Write” are ready.

Meanwhile the Asynchronous I/O thread and user exit are starting and completing multiple concurrent I/O operations.

This figure shows the present invention with even more overlap of processing and physical I/O. There is no blocking on I/O as the asynchronous I/O thread will start I/O as it come available and will, through the exit, mark the associated IOBUFFER complete immediately at I/O completion. More work is done with less elapsed and less processor overhead. Available resources are applied to the application without any changes to the application. In this example the same application will run on a minimal single processor system or on a 4 processor, counting hyper-threading, server with no changes, only more quickly.

1.4.8 Open/Close

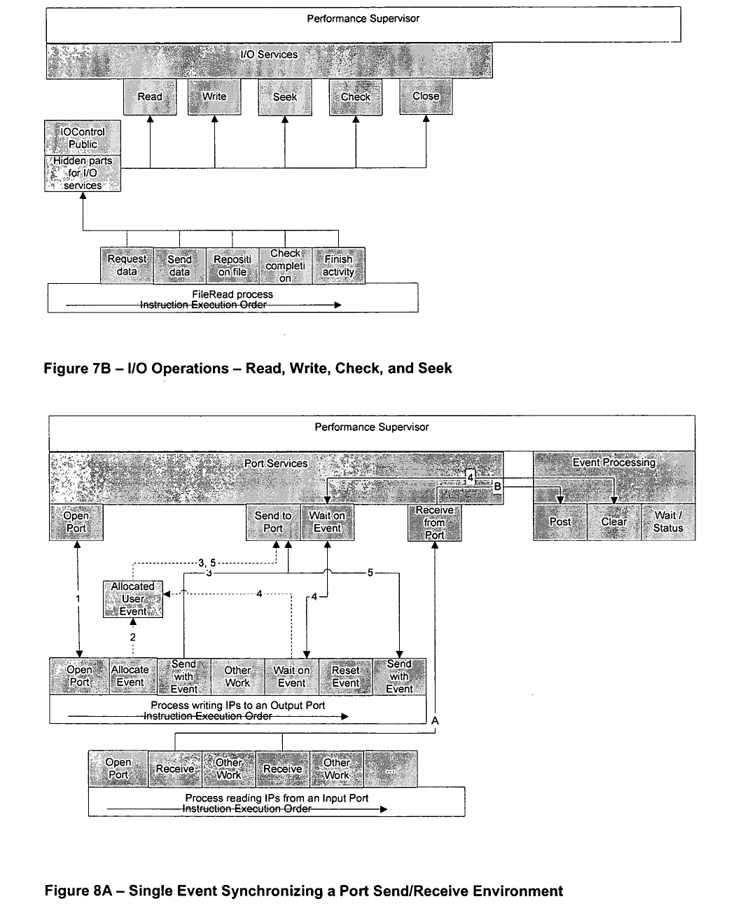

FIG. 7A expands the description of I/O Supervisor Open. The object of the Open service is to analyze the environment and create an initialized IOCONTROL class, the address of which is returned to the caller. All the fields of the IOCONTROL are reserved for the supervisor; the user does not have access to modify the contents. All the I/O services are presented as classes to the IOCONTROL or the IOBUFFER which is connected with the IOCONTROL.

Methods of the created IOCONTROL include reading a file, writing a file, repositioning the current read or write pointer, checking the status of an operation, and closing the IOCONTROL when complete.

In this invention an IOCONTROL can support simultaneous READ and WRITE operations. This is especially useful in working with temporary files. Files may be extended while previously written segments are being read back.

As demonstrated in earlier figures, the I/O supervisor determines the most efficient processing options, unless overridden by the user. These options are stored in the IOCONTROL for inspection by the related services. Also demonstrated is how an open request may be linked to a real file, a temporary memory backed file, or even a networked service. The files may be processed in synchronous, asynchronous, memory mapped, or in-line modes.

Close will wait and complete any outstanding activity then destroy the IOCONTROL class before returning to the caller.

Some items which may be specified are:
A filename for read and a filename for write. They may both specify the same file.
The maximum concurrency level of I/O operations
Sharing and Security options
Creation flags such as “Create_Always” or “Truncate”
Operational flags such as “No_Buffering” and “Virtual_IO”

To the “black box” process the open appears the same. The process may be reused in multiple environments and will select the appropriate operating mode within the parameters supplied.

1.4.9 I/O Operations

FIG. 7B depicts several methods which operate on the IOCONTROL class described in FIG. 7A.

The executing process may:
Allocate IOBUFFER classes which act upon an IOCONTROL.
Request a read operation against the IOBUFFER/IOCONTROL. The request will be routed to the Read I/O service appropriate for the flags in the IOCONTROL.
Request a write operation against the IOBUFFER/IOCONTROL pair.
Request repositioning of either the read or write component
Check completion of the IOBUFFER operation.

The I/O services presented by this invention are preferred to conventional I/O. Conventional I/O will block the calling thread, in this case the running dispatcher. The supplied I/O services will keep the running process and dispatcher active until no other work is available. This overlap is a significant performance factor.

All I/O services are thread-safe. A major network may have hundreds of concurrent processes running. The I/O supervisor ensures that any process may enqueue a request without blocking. The I/O supervisor protects each worker thread from over-writing the work queues during critical update periods. The user process is written for simple single threaded operation, the supervisor makes its calls thread safe without intervention. The supervisor may initiate multiple threads for one running process, for example, one blocking synchronous I/O worker thread per requested I/O operation.

1.4.10 Dispatching Enhancements

So far the DISPATCHER SUSPEND and DISPATCHER ENQUEUE calls discussed are driven by the I/O supervisor waiting for I/O to complete, or the Input/Output ports suspending for capacity reasons. The Event Services of this invention extend a level of control out to the user process. FIGS. 8A-B depict the use of Event Services and how a process may avoid unsolicited suspends.

By knowing when an operation will suspend the process may switch to other non-suspending operations. By incorporating a mini-dispatcher driven by a list of events the user process may detect which services have completed and make efficient use of available resources. These conditions are explained after the basic functions are presented.

1.4.10.1 Events

An event is the heart of the Event Processing Service. It is a simple class with a flags indicating set or posted, and suspended or not. A user field is available and a numeric post code.

Its main purpose is to be passed to other services or processes and used for synchronization between them. This is quite general as a concept. Specifically an event may be specified:
On any Read or Write I/O service. Rather than having to check the requests individually the process may WAIT on the supplied event and have the remote service post that event when complete.
On any InPort RECEIVE service. Like the I/O supervisor, the Port services will post the event when an IP becomes available. Likewise on any OutPort SEND operation the Port Services will post the event when the queue count drops below capacity.
On an event created by one process and sent, via an IP, to another process. The first process may WAIT until the other process has completed its work on the supplied data.
The FileRead process has up to four concurrent IOBUFFERS, an OPT input port, and an OUT output port. It has a dispatcher that is alerted when any of these concurrent processes are ready to run, goes to a routine specific to the ending event, and performs more work.

1.4.10.2 Wait

This service will inspect a supplied event and will DISPATCH SUSPEND the calling process when the event is not posted. This simple operation extends the overlapped operations to the user process.

1.4.10.3 Post

This service will mark an event as “posted”. The event has a field identifying the owning process. Post will, when the owning process is suspended, DISPATCH ENABLE that process. Post is how one service or user process may signal completion to another.

1.4.10.4 Event Lists

An EVENTLIST is a class which contains a list of EVENT classes. It is defined by a process to group events for dispatcher like functions. The WAIT service will accept a single event, satisfied when 1 of 1 event is posted, or may be given an EVENTLIST class and request to be suspended until n events are complete. The normal mode is, for example in FileRead, to wait on 1 of n events in a list.

1.4.10.5 Putting it together

FIG. 8A depicts two processes. One is generating IPs sending them out an output port; the other is receiving IPs from an input port and using them.

The “Writing” process will open an output port (1) preparing it for data. Nothing is written at this time. The “Reading” process will also open an input port (1 not shown) preparing it for data. For this example, the “Writing” process will use event processing, the “Reading” process will not.

Although operation may occur in a different order, assume “Reading” next issues a RECEIVE against its input port. Since no data is there, and no event was specified, the Port Services for “Reading” will suspend the process letting the dispatcher select “Writing”.

“Writing” is designed for event mode processing. Its first operation is to create an event. This call goes to Event Services (2) where an EVENT class is created. The address is returned to “Writing” for future use.

“Writing” creates many output IPs and SEND WITH EVENT is issued against the output port. Upon receipt of these IPs the Port Services, outport processing, detects the downstream “Reading” process is suspended and calls DISPATCH ENQUEUE. There were however, more IPs sent than the downstream input port capacity. Without the event specified Port Services, outport processing, would have suspended the caller. With the event it returns a special code “EVENT_SET” and removes only the number of IPs that fill the port to capacity. The “Writing” process receives control and continues with other work, typically preparing more IPs from an input buffer. Eventually it will issue a WAIT on the event (4). Event Services, wait processing, will inspect the related event and will:
If the event is already posted, return immediately to the caller
If not, as in this case, it will DISPATCH SUSPEND on the event and give the dispatcher an opportunity to find other work.

That other work will be “Reading” which has already been enqueued on the ready queue and is now selected for dispatch. “Reading” will return from the previously issued RECEIVE with IPs from the inport. It will perform some operations on those IPs then return to issue another RECEIVE request. Depending on operational factors it will either return immediately with more work or DISPATCH SUSPEND as before.

“Reading” in taking IPs from the inport (A) will have reduced the current count below capacity. Port Services, inport processing, detected an event was specified, and that it was in a non posted state. It issues a POST (B) against the event which detects that “Writing” is currently suspended. It issues a DISPATCHER ENQUEUE against “Writing” which puts it on the dispatcher ready queue. The operation of “Reading” against the input queue has satisfied the WAIT from “Writing”. This operation continues until no more data is processed and both processes terminate. It doesn't matter to WAIT whether or not the event was posted. If not posted it waits, if already posted it just clears the event and returns.

In multiple processor systems both “Writing” and “Reading” may operate concurrently and either one will suspend when it gets ahead of the other. “Writing” by using events, “Reading” by not. Events may have been specified by one process, the other process, or both. The supervisor is prepared to handle any combination.

1.4.10.6 Using an EventList

FIG. 8B depicts a more complicated but efficient way to handle data coming in from different sources. In this example “Reading” will process data from either the IN or OPT input ports, taking data from the next one to become ready. “Writing” is supplying data for the OPT port, data for the IN port is coming from another source.

“Reading” will allocate two events (1), at this time they are unrelated. It next allocates an EVENTLIST class (2) and populates the array of events with pointers to the two events created in (1) above. Preparation is complete and the master loop is entered. It is primed with flags that both ports are ready for processing.

“Reading” loop will RECEIVE (3) from the IN port. Data is available and is processed; the disposition of that data is not shown for simplicity purposes. “Reading” loop will RECEIVE (4) data from the OPT port (4). In this case data is NOT ready and the associated event (Event 2) is marked as active, not posted. The loop goes back to RECEIVE (3) but this time data is not available and the associated event (Event 1) is marked as active, not posted. The “Reading” mini dispatcher runs out of work and issues a WAIT against the EVENTLIST specifying “1 of 2” events must be posted to return.

“Writing” at some time will send data to its output port (A) which feeds the input port for “Reading”. As in FIG. 8A, port services will post the matching event (Event 2). POST will see it is part of a list, that 1 event is now posted, and that the wait only requires 1 event to be satisfied. “Reading” is put on the dispatcher ready queue for future processing.

“Reading” (5) will receive control after the wait, and by inspection of the list will know which event(s) were posted. It will issue the appropriate RECEIVE operations, process the data, and again enter the dispatcher loop. “Reading” will now wake up and be notified on whichever event is posted, or both.

1.4.11 Deadlocks

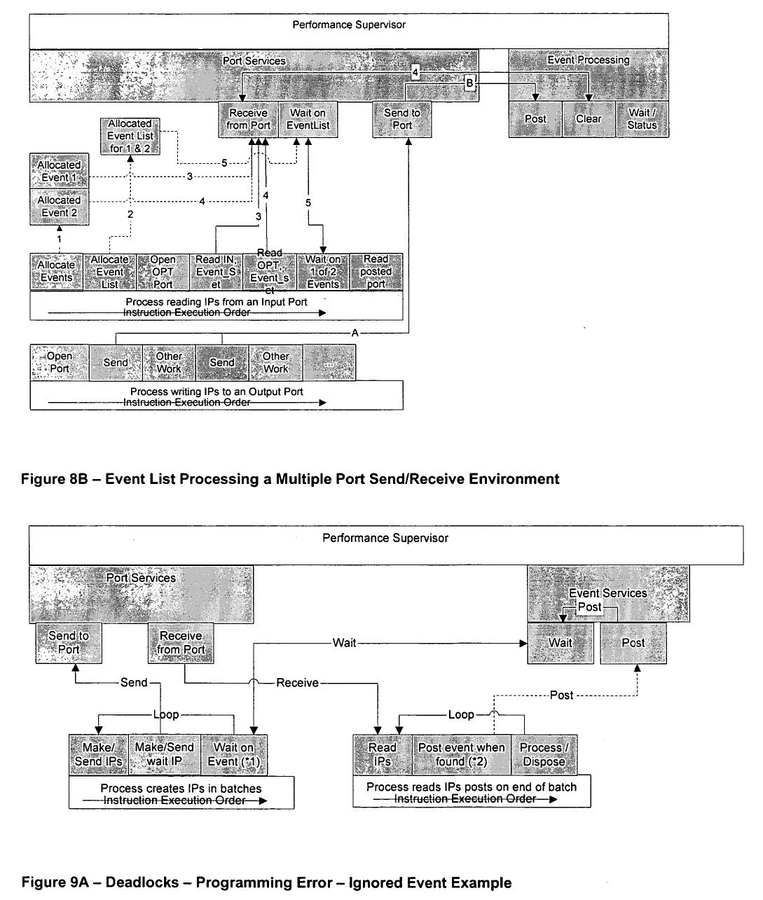

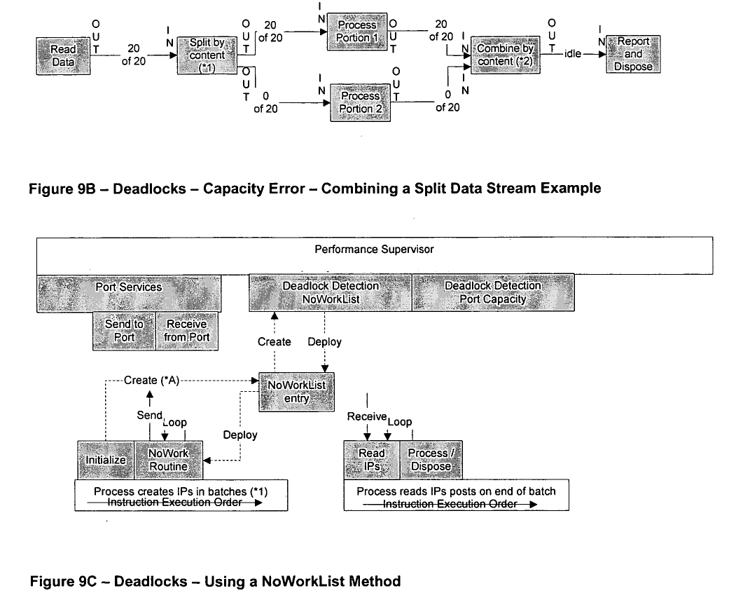

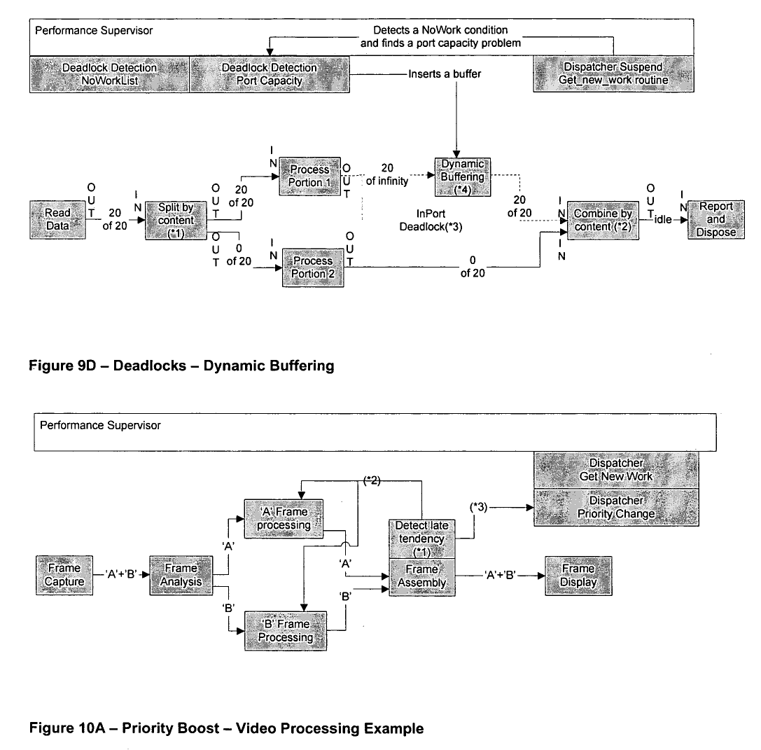

FIG. 9A-B depict two conditions that may plague FBP applications. That is the deadlock condition where no process may run because the expected data doesn't arrive. Two examples are shown:
A programming error where required IPs are not sent, and
A capacity error where the capacity of each process is exceeded before required data can be sent down a different port chain.

The dispatcher GETNEXT service (ref FIG. 2A) detects a deadlock condition when all of these conditions are met:
No work exists on the ready queue
All other dispatchers, if any, are idle
No I/O activity exists, either synchronous, asynchronous, or connected network traffic
FileMonitor is not active (covered later)

1.4.11.1 Ignored Event Deadlock

FIG. 9A depicts a sample network that fails due to deadlocking.

The high level flow is:
“Creates” process loops making and sending IPs to a downstream process (“Reads”).
“Creates” adds an event to the last IP in each group. It will wait on the event before continuing the loop and sending more data, plus the event again.
“Reads” will read and process the IPs. When it detects the event it issues a POST.

In this scenario, “Reads” either does not receive the IP or fails to detect the event. In either case the event is never posted, “Creates” is waiting on the event, “Reads” is waiting on the input port.

Nothing can happen and the dispatcher detects a DEADLOCK condition. Deadlock processing, with no exits activated, will:
Terminate all idle dispatchers. Only the active dispatcher thread continues.
Signal the message logging threads to dump the captured messages, see a later discussion of the message service
Creates messages for all processes in the system and their current status. In this case it would show “Creates” is waiting on an event and “Reads” is waiting on the input port, with no IPs in the queue
Terminate processing

1.4.11.2 Capacity Deadlock

FIG. 9B depicts a typical network that is prone to capacity deadlocks. It is characterized by two or more streams of data that are split then combined.

Each block in this figure represents a process in the network. The name of each port is written next to the block: Input ports on the left, output ports on the right. Also shown is the current IP count and the capacity, for example 0 of 20.

In this figure, “Read Data” will create IPs and send them to “Split by Content”, which has two outputs: One to “Process Portion 1”, the other to “Process Portion 2”. Each of those processes sends their output to one of two “Combine by Content” input ports. That process will merge the data and send it to “Report and Dispose”.

Under “normal” circumstances the combine step (2) will:
Read a block of data from each input port
Determine which block should be forwarded to the output
Continue reading data streams from each port, merging them into a single stream

What will happen if the lower path does not create a record until 100 IPs have been sent out the upper path?
“Combine by Content” will wait on the lower path for a record
“Process Portion 1” will create IPs until the output port reaches capacity, 20 of 20 in this figure, then suspend on output port full.
“Split by Content” will continue to run sending IPs out the upper path until its output port reaches capacity and suspends.
“Read Data” will continue to run sending IPs until its output port also reaches capacity, and suspends.

At this time no process is ready to run and no I/O activity is pending. “Read Data” may have I/O outstanding but that will eventually end.

The network deadlocks and the report will show “Combine by Content” is waiting on input from one port while the other port is at capacity (20 of 20). “Report and Dispose” and “Process Portion 2” are both waiting for input while all other processes are blocked on full output ports.

Changing “Combine by Content” to recognize this condition and internally hold the IPs would correct the problem. Likewise changing the network diagram to permit more capacity than the expected IP counts would permit the one IP going through the lower path to eventually reach “Combine by Content” and have it read again read from the upper stream.

For this discussion this is a capacity deadlock and will terminate the application as described in FIG. 9A Ignored Event Deadlock.

1.4.11.3 Nothing left to run—NoWorkList

FIG. 9C depicts the NoWorkList method to avoid, or exploit the deadlock.

The network is similar to FIG. 9A except an event is not passed between processes. In this case “Creates” will allocate a NOWORKLIST entry, which registers it with the supervisor. The purpose of a NoWorkList entry is to specify a routine to be given control whenever a deadlock is detected.

“Creates” exploits this feature and will:
Create the NoWorkList entry and do nothing else. It suspends on an event used to trigger shutdown, covered later.
“Reads” will initialize and attempt to read input IPs. None are available so it suspends
All other processes in the system eventually run out of work and suspend
The dispatcher detects a deadlock condition and starts deadlock processing. This time it locates the NoWorkList entry and goes to the exit
The exit, located in “Creates” will make a batch of IPs and send them to the downstream process. This clears the deadlock condition and the dispatcher starts running the now “Ready to Run” processes.
Eventually all created IPs complete processing and the dispatcher again goes to “Creates” NoWorkList exit. This loop continues until “Creates” decides enough IPs have been created, closes the output port, releases the NoWorkList entry, and terminates
Each downstream process will clean-up and terminate
When all processes have ended the dispatcher will again detect nothing ready to run but this time will terminate normally as all processes have ended.

The network in this figure will batch feed work but only when nothing else is ready to run. This pulsing technique can be useful in some circumstances where a metered rate of processing is required.

1.4.11.4 Capacity Services—Dynamic Buffering

FIG. 9D depicts the network of FIG. 9B with one major change; Dynamic Buffering is available as a dispatcher option.

The exact flow described in FIG. 9B will happen until all processes are suspended and the dispatcher detects the deadlock condition. At this time it determines that “Dynamic Buffering” is available and inspects the deadlock conditions for:
A process (“Combine by Content” (2)) is suspended on one input port while another input port is at capacity.
The feeding process of the port at capacity is suspended on output to that port

Deadlock processing determines that “Combine by Content” is deadlocked on a capacity problem. The apparent solution is to permit the capacity of this input port to be extended.

Deadlock processing will:
Create a pseudo buffer at the input to “Combine by Content”
Transfer the pending IP pointers to that buffer. The data for each IP remains connected to that IP.
Mark the port as having Dynamic Buffering active so when “Combine by Content” eventually reads data it will be supplied data in the correct order as described later in this figure.
Change the port capacity to accept more data, making the upstream process “Process Portion 1” ready to run.
Returning to normal dispatching

One of two events will occur. Either the downstream process will receive the IP on the lower path and resume normal operation or the upper path will continue to receive many more IPs.

Receiving more IPs:
The output port processing routine recognizes it is sending to an active dynamic buffering port. The chain of IPs will be added to the pending chain of IPs in the pseudo buffer. If memory is not constrained, output port continues without interruption.
When memory starts to be constrained or the number of IPs in the system reaches a threshold the pseudo buffer must be processed. Each IP is moved into a dynamic buffering compressed area (64 MB blocks are allocated) as required. The IP is returned to the pool and the data area, if NOT user defined, is compressed along with the IP controls. User buffers are not processed as their location is user allocated and cannot be simulated on restore. A new pseudo buffer is established to handle additional incoming IPs. Control returns to normal output port processing
Eventually the number of compressed blocks presents a problem. They are moved to the paging dataset, or optionally to an installation defined location. At this time there are:
   Input pseudo buffers
   Compressed 64 MB buffers chained in order of receipt
   Compressed 64 MB buffers written out to a drive.

At some time the target process will start to draw IPs from the input port. Unwinding the dynamic buffer follows the following path:
The original IPs that were in the input port are received by “Combine by Content”.
The next Receive for IPs will have dynamic buffering move IPs from the first pseudo buffer and ready them on the input port. Only the capacity of the port will be moved at a time to avoid flooding the downstream application.
After the pseudo buffer is emptied, the first compressed buffers will be decompressed into pseudo buffers.
As the compressed buffers are emptied, compressed buffers residing on paging or external drives are read into memory as required.
Once all the higher levels of saved data is processed, the staging area, input to the dynamic buffer process, are unwound to the output side.
When all dynamic IPs have been sent to the downstream process, dynamic buffering is disconnected from this port and processing returns to normal suspend/resume mode.

Dynamic buffering is not the preferred method for capacity prone network design. It is designed to handle the occasional port overload condition.

1.4.12 Performance through Priority Changes

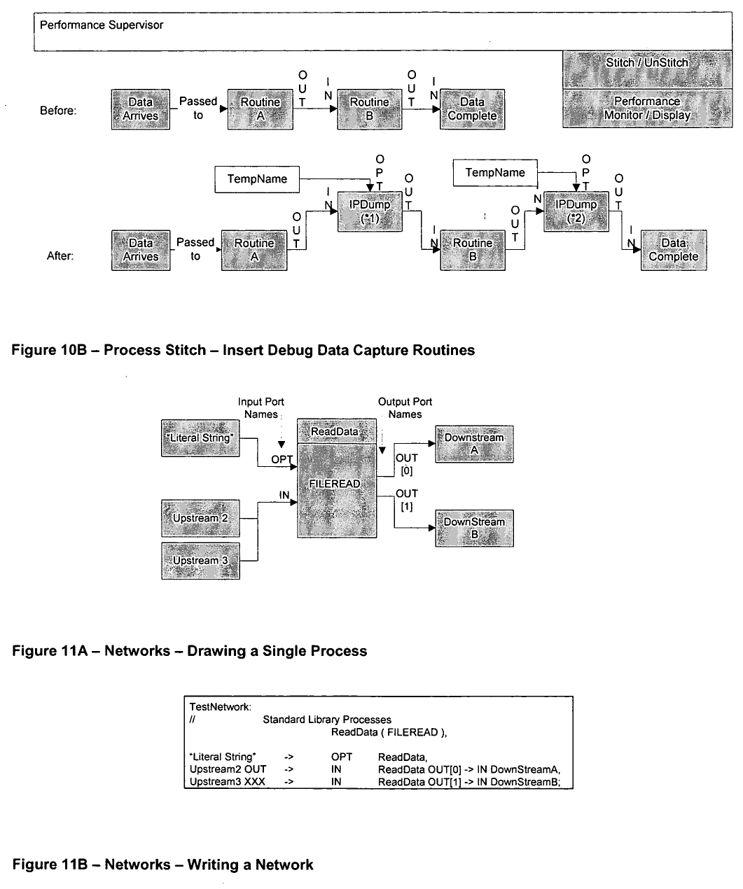

FIG. 10A depicts a network where a minimum throughput rate is required. The network is a real time video processing application where (approximately) 30 frames must be processed per second. Any delays over 35 ms per frame may cause frame dropouts.

A typical video stream contains an “A” frame, which contains all the video data, followed by three “B” frames which contain differences from the preceding “A” frame. “Frame Analysis” sends each type to its own processing routine.

“Frame assembly” has some code (1) to detect when a) one type of processing is consistently slower that the other type, or b) when both streams are becoming marginal in their processing times. It can signal either processing type via a port connection (2) to reduce the level of processing so the frames come through more quickly. It can also signal the dispatcher (3) to boost the dispatching priority of either, or both, frame processing routines.

Priority boost will assist the slower processing side to meet the timing objectives. The priority affects both the dispatcher ready queue ordering, and when selected to a dispatcher, the operating system: dispatching priority.

1.4.13 Real-Time Network Modifications—Stitching

FIG. 10B depicts the scenario where “Routine B” may be behaving strangely. A monitor program is instructed to capture the data streams into and out of the process. The upper four blocks show the original network; the lower 8 blocks show the results after stitching. Two process and two IIP strings have been inserted.

The object is to reroute the output of “Routine A” into “IPDump 1” and its output back to “Routine B”. I.e. insert “IPDump 1” into the input leg of “Routine B” and IPDump2 into the output leg.

The Stitch service can perform that insertion and ready the new process for the dispatcher. Stitch will:
Create two PROCESS and PROCESSCONTROL blocks for each process to be inserted. In this case Stitch is told to prepare the IPDUMP process and a control IIP for it. Each IPDUMP will have an InPort named “IN”, an OutPort named “OUT” and another input port called “OPT” which will have the control IIP defined as input.
Locate the output OutPort; it's matching DESTINATION; and the target InPort.
Separate the DESTINATION from the existing InPort and reroute it to the stitched input.
Route the new OUT OutPort DESTINATION to “Routine B” IN InPort
Repeat the process for the second IPDUMP being inserted after Routine B”.

A process may be unstitched as well. E.g. remove debugging routines.

1.4.14 Reuse

FIG. 11A shows a sample process (FileRead) and how it may be displayed on paper. By convention input ports are shown on the left and output ports on the right. I.e. processing is left to right. Often option ports are shown as entering at the top, this is optional.

The process block has two names; the top is the name (ReadData) this process will have in the network diagrams, each reference within a network definition must be unique. The lower name is the component name (FILEREAD), or what name to locate in the library. Many references to the same component name are encouraged.

The name assigned to each port is written next to the line, just outside the process block. This name must match the name the process opens. If spelled incorrectly the process will not find the port and open will fail. Each port may be a member of an array with index values ranging from 0 to 19. If specified it is inside square brackets [n] immediately following the port name. If not specified array index 0 is defaulted.

This example shows two processes feeding one input port, the input and output ports are not shown for simplicity. This is a valid configuration.

FIG. 11B shows how this may be coded as network input to the application. Required syntax is to show InPort ProcessName OutPort->InPort ProcessName OutPort . . .

A comma “,” is inserted to end a phrase. For multiple inputs to a process, the process name is repeated with the new input port. Multiple outputs from a process follow the same rule.

In this diagram there are three inputs to ReadData (OPT, IN and IN repeated) and two outputs (OUT[0] and OUT[1]).

1.4.14.1 Multiple Concurrent Processes and Networks

FIG. 11C depicts a network input with a sub-network.

“RegionCalc:” defined at the end of the file has a single process (SPECIALC) and has one input port (IN) and one output port (OUT). It is known externally as “RegionCalc” and may be used as a process in any statement. In this diagram it is referenced in the “Region1 Process (RegionCalc:) statement, notice the “:” after the name identifying this as a LABEL.

The network shows “DATA” as the source and “LIST” as the target ports. These two fields are pseudo network ports which are used as input and output to the network.

This diagram demonstrates how processes may be reused, and how a network may be reused within a definition. This invention supports predefined “canned” networks that may reside in a library.

1.4.14.2 Dynamic Networks

FIG. 11D depicts a definition of two Dynamic Networks: “CommandAdd:” and “CommandRep:”. Anywhere in the network the “Add” process is used, this invention will load the referenced network and treat it as part of the network.

An additional feature of Dynamic Networks is that they may terminate and be released from the application. If data is sent to them again they will be reloaded. There may be hundreds of service routines, each with a dynamic network, which will be loaded only as required. This is great for seldom used commands but should be avoided for high use commands.

A dynamic network can be made resident if the upstream process does not close the port feeding the network. Since the connection is open the downstream network cannot close.

1.4.15 Pooling the Information Packets

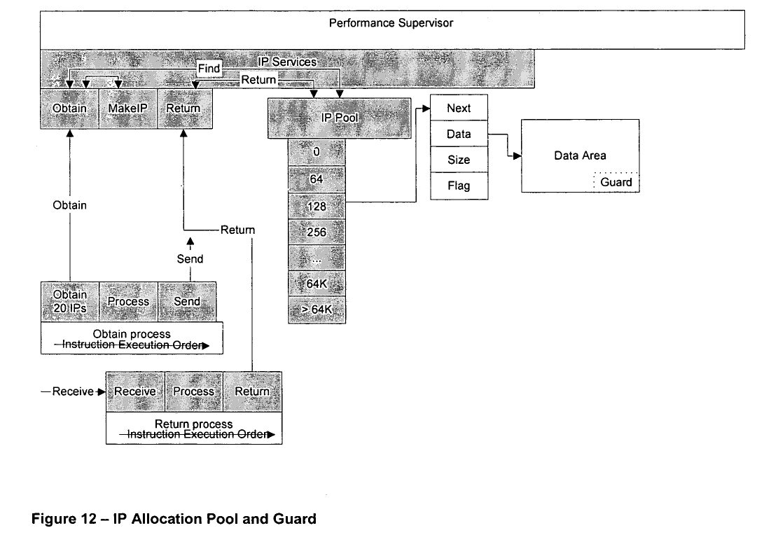

FIG. 12 depicts the life of an Information Packet (IP) and how this invention improves the performance through pooling. In most applications the life of an IP is short; often the system overhead of allocating and freeing the storage exceeds other processing. This invention improves the process by:
Reusing a returned IP on another request rather than returning the storage and allocating it again.
Only allocating the data area in multiple of two with the minimum size of 64 bytes. Sizes then are 64, 128, 256, 512, 1K . . . Up to a maximum of 64K bytes. Request over 64K are handled individually.
Allocate only in blocks of storage containing many like sized IPs
Maintaining a pool of returned IPs ready for quick assignment to a new request. There are 12 free chain headers in the pool. One for each data size group from 64 to 64K bytes and one for zero or no data requested for the IP.
Each IP control carries a single character with the size index

For example a request for an IP with 100 bytes of data area will create an IP with 128 bytes of data and carry a size index of 2. (0 for no data, 1 for up to 64 bytes, 2 for up to 128 bytes, etc)

The “Obtain” process requests 20 IPs each for 80 characters. The request goes to the performance supervisor—IP Services where a check is made for available IPs in index 2 of the pool. Based on the size requested, index 2 is calculated rounding the 80 characters up to the 128 character pool size represented by index 2.

On startup there are no IPs in the system; the IP POOL is empty so (Find) comes back empty. Each required IP will be allocated, and if a data size is also required, the requested size will be assigned the matching size index and the fixed data size for that index is allocated. In this example 20 IPs will be created, each will have the index value of 2 and each will have a 128 byte block of memory assigned.

IP services also maintain a guard to catch overwriting of the assigned area. The actual size allocated will be slightly longer and a special, seldom used, binary sequence is inserted at the end of the data buffer. This guard is checked on all IP operations.

Eventually the IPs will be returned, singularly or in groups. They will not be deleted but chained in the IP Pool (Return) in a push down queue appropriate for the assigned index. These sample IPs will be assigned to the queue for index 2 or 128 byte data blocks.

Subsequent requests for IPs will first look (Find) in the IP Pool. The requested number of IPs will be taken from the pool and assigned; the data area of each will be cleared. If more IPs are requested than in the pool, new IPs will be created and the total request will be satisfied from pooled and new IPs.

When memory becomes constrained, the Performance Supervisor will trim excessive pooled IPs.

1.4.16 Message Processing

Flow Based Programming (FBP) networks may have hundreds of processes defined, many of which will be ready to run at any time with as many concurrently active processes as dispatcher threads running.

Conventional log file message writing will corrupt the log caused by mixing parts of various threads messages. Complex locking of resources whenever a message is written would help this problem but the programming overhead for every process author would be overbearing.

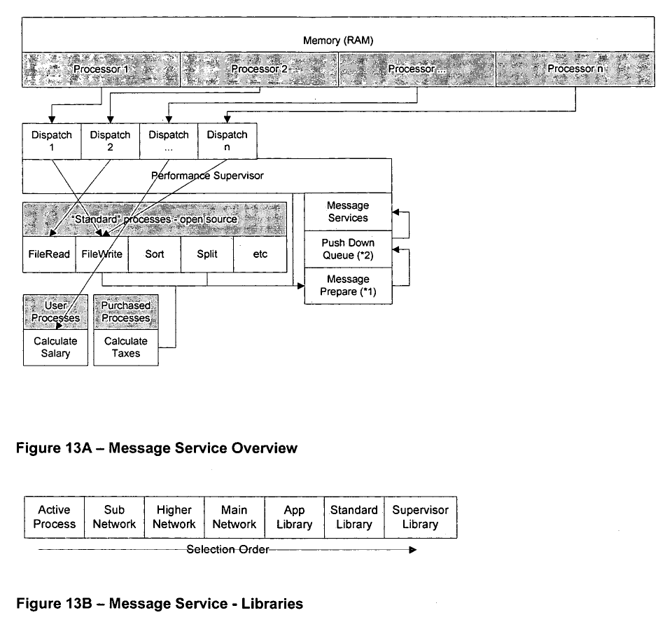

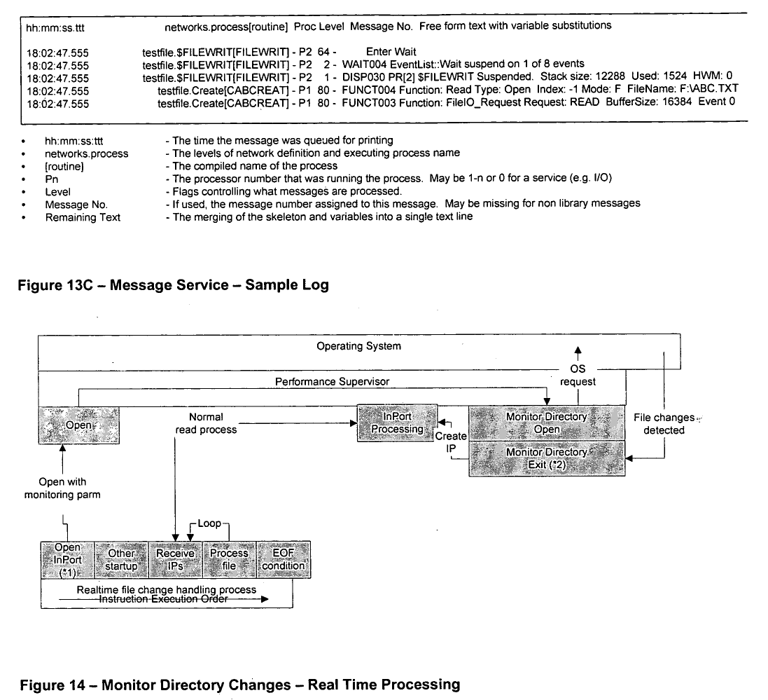

Consistency of message format would remain a problem, as would the identity of the message source. This invention's Message Service overcomes these and offers other advantages. FIG. 13C depicts a sample log portion showing:
Messages are written to a single log in a consistent manner and format including the time of origin
The originator of each message is identified by network, sub-network, network name, and process component name.
The active dispatcher or service thread running at the time
The message trace level
The MessageID for messages from a message library.

1.4.16.1 Overview of the Message Service

FIG. 13A depicts the same environment as the introductory diagram in FIG. 1B with the Message Service added. Three processes plus the supervisor are originating messages.

The Message service has several components handling this environment including:
A Message method which executes under the dispatched process. This method has no interaction with any other message function and will not block or suspend.
A Message logging thread which acts upon the messages created by the method
Standard macros to build Message Libraries
A hierarchy of message libraries. Messages may be defined within a process, within libraries specified on the network DLL statements, within libraries specified on higher level network DLL statements, within the standard library, or supervisor standard messages
Messages by language. The same message number may appear in different language libraries.
Variables coming from the message invocation are in a fixed order (1, 2, 3 . . . ). The order of message substitution may change language to language according to applicable grammatical rules.
The message service ensures all messages are written before permitting the process to terminate.
Messages are defined with flags describing the type of message. A message may be in more than one class, for example IOSupervisor and ERROR.
Message logging is done by message class. There are three levels of message logging:
   Print—Are entered into an array (currently 100 entries) of pending messages. The array is processed, writing messages to the message log
   Capture—are entered as a print request except are not sent to the message log. On error shutdown, such as a deadlock, these capture only and intermixed print level messages are written to the log.
   Ignored—Do not pass initial filtering and are never printed

FIG. 13A depicts four dispatchers running processes. One of these (FileWrite) is creating a message. The flow, issuing a message, is:
The MessagePrepare (1) service is called. It first checks the message level against the capture and print levels. If there is no match the service returns immediately to the calling process, ignoring the message request.
MessagePrepare creates a message service control and performs a thread-safe push of the control onto a queue (2). If the message service is idle, it posts an event to wake up the service, then returns to the calling process. The message control includes such items as the message class, the current time of day including milliseconds, the originating service such as dispatcher n or SyncIO n, message ID, and variables converted to text according to the data type fields in the message layout. For freeform messages the entire text is saved in the control as the process may overlay storage areas once it regains control. All information to be printed must be captured while available.
The MessageService is a single thread. It does not have to be thread-safe except in pulling work off the new work queue (2). New message requests are pulled from the queue and inserted into the pending array.
Each unprocessed message in the array is prepared for printing. First the message number, if any, is located in a chain of quick lookup hash tables containing all messages defined at each level. Language of choice is used in selecting the appropriate message.
The message skeleton is scanned substituting variables whenever a % n field is located. The n represents the nth variable in the list.
The message log entry is assembled. FIG. 13C is a sample message log. The time is converted to a standard format, the process is located in the chain of networks, the process name and component names are captured as the running service, message class, and message number. The log entry is written to the open message log
MessageService processing continues until all pending messages are printed. The thread goes idle waiting on new message arrival or shutdown notification. It uses an EVENTLIST for 1 of n events to be posted.
The calling process will be suspended when the message array is full, and resumed when the message service processes the backlog.

On shutdown the message service ensures all outstanding messages are written. At any time the message service may be alerted by another service to “Dump all Messages”. It will format and print all captured messages. The most common request to dump all comes from the dispatcher when it detects a deadlock condition and initiates shutdown.

1.4.16.2 Message Libraries

A message library is a compiled module with the external name “Messages”. Only one library may exist in a DLL as the message library has a specific name. There may, however, be unique messages in each process within a DLL, and one message library per DLL. Each network may have multiple D Ls defined and each application may have nested networks.

As each network is loaded the supervisor looks for a copy of the “Messages” program in each DLL specified. A Messages program normally contains many NetMessage calls (see below), each defining one message. The Application and invocation levels also load DLLs and invoke the appropriate “Messages” routine if found.

A sample “NetMessage” compiler statement follows:
value=NetMessage(_{—}net, “CAB001”, TRACE_{—}USER+TRACE_{—}ERROR, “GetData error %1 on capture file: %2”);
where:
value—indicates if an error occurred “defining” the message
_net is a parameter passed to the “Message” program, it identifies the current network
“CAB001” is the example message number
TRACE_USER+TRACE_ERROR are the message class flags
“GetData error %1 on capture file: %2” is the message text. There are two variable substitutions defined, %1 and %2. During message log creation the first variable will replace %1, likewise the second replaces %2. There may be multiple occurrences of each variable and they may appear in any order.

1.4.17 Real Time File Change Monitoring

Everything described to this point appears as “batch” processing where a network is started, continues processing until no more work exists, then terminates. If the dispatchers go idle, with no I/O outstanding, it is considered a deadlock and the program terminates. This presents a problem for applications that process files in real-time. There will be long periods when the application is waiting for a file to arrive.

FIG. 14 depicts a “Realtime File Change Handling Process” and how this invention will process the real-time requests.

The solution is in two parts:
Real-time changes will be reported to one, or more, requesting processes via a Port Services defined input port. The process uses a standard receive call to obtain a change noitification. There are no capacity limits on file monitoring input ports.
A Monitor Directory service in the performance supervisor. When this service is active it also disables deadlock detection on the input port attached to the service. Other deadlocks are still active such as the “Capacity” deadlock described in FIG. 9B.

To activate the service a process will open an input port. The open request will not specify a normal port name, instead will specify monitoring and supply the directory name to be monitored. Port Services—Open will detect the parameter string and call Monitor Directory Open (1).

If not already started, a Monitor Directory Exit will be established and operating system calls will link the target directory to the exit. The operating system will notify the exit on every change made to a monitored directory.

The Monitor Directory Exit (2) will inspect the operating system change information including directory and filename. It will be first matched to one or more processes monitoring the specific directory then matched to filename filters such as *.TXT. Requests that fail all matching entries are ignored.

For each port matching the file change, an IP is created and queued to that port. Port Services will treat these IPs as normal input IPs except the calling process (Monitor Directory Exit) will not be blocked on capacity. The target process, when suspended, will be DISPATCH ENQUEUEd. Note: There may be multiple processes requesting monitoring, some may specify the same mask. Each port will receive an IP for this change notice.

Monitoring continues until the requesting process closes the port. This Close breaks down the Monitor Directory tables and, when no requests remain for this directory, cancels the operating system call.

1.4.18 IP Push Processing—Port Turbo Exits

The present invention includes a method to push data to a process's input port turbo exit without dispatching the target process. A single dispatch of a system “Turbo” process will push data through a network of exits stopping only when all data is queued at normal ports for process dispatch.

The turbo exits reduce system overhead through reduced dispatching, no changing of IP ownership, and elimination of input port queuing. The control block structure for port processing, as shown in FIG. 2C, is modified for push processing. Also new is a work queue containing pointers to each port with pending push IPs.

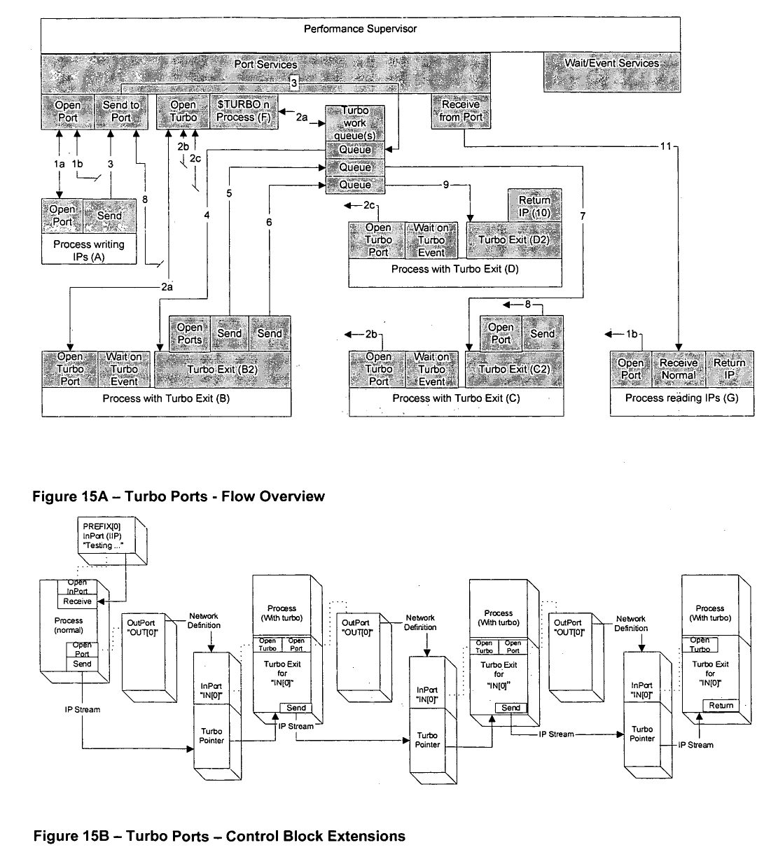

FIG. 15A depicts an environment, which may be represented by processes in more than one network, in which one process originates data which is passed through three turbo exits, and either deleted or sent to a pull mode port.

Referring to FIG. 15A, the operational and data flow is as follows:
The dispatcher sees five processes (A, B, C, D, and E) that may be run and enqueues them on the dispatcher queue. They may gain control in any order or, on multiprocessor systems, may run concurrently. For this discussion they will be referenced in ABCDE order but this invention will operate properly in any order.
A process (A) is dispatched and:
   Opens an output port (1a).
   Creates a batch of IPs (not shown)
   Sends that batch to the output port (3). Port services queues the data on the downstream destination for future processing. Note: The downstream port has not been opened in this discussion. If it were opened more processing would occur.
   Loops back to create and send more IPs, stopping when the output port blocks.
Another process (B) is dispatched and:
   Opens an input port (2a) specifying a turbo exit address, normally residing in the same compilation (B2).
   Port services detects that no turbo environment has been started. It then corrects the situation:
      Creates a system process called $TURBO1 (F)
      Creates a work queue for push mode operation (2a)
      Enqueues the process for eventual dispatch
      Locates the upstream destination block finding pending work (3). This work is referenced by a work queue item and placed on the newly created Turbo work queue.
   Waits for the turbo exit to terminate. This process goes idle for most of the program execution.
Process (C) and (D) gain control and operate the same as (B) above except the turbo environment has already been established. Upstream data, if existing, will be redirected to the existing turbo work queue. At this time Processes B, C, and D are waiting. Exit routines B2, C2, and D2 are defined to Port Services and associated with their appropriate destination blocks
Process (E) gains control and opens a normal input port (1b). It then issues a “receive” against that port; since there is no work at this time process E suspends.
Process F, the new $TURBO process, gains control. Its operation is to select the top queued item on the turbo work, process that work, and loop back until no work remains. It will then wait for a post from Port Services to look for more work or shut down. Processing includes:
   Dechain the pending work push down queue (not shown) and merging any new work into the work queue in priority order
   Dechain the top work queue item
   Branch to the referenced turbo exit (4) with the list of IPs.
   The exit processes the data, and in this case sends some data to the inport for process D, and some data to the inport for process E. Open processing is not displayed.
   Port Services will find the downstream port is opened for turbo and will queue the request on the turbo work queue.
   When the input data has been processed the exit returns to $TURBO1 where the cycle repeats until the input queue is empty.
Processing for exit C2 is similar as above except the output stream produced is directed to a normal “inport”. It is queued on the “Destination” block and the process is posted if waiting on input data.
Processing for exit D2 is similar as above except the exit returns all IPs. Nothing is queued for downstream processing.
Process G gains control after the suspended “Receive” (11) with a normal stream of IPs.

In this demonstration it should be noted that none of the “send” operations know what type of downstream processing occurs with the data. This is by design and permits the same process to feed different types of input processing.

Since pull mode InPort processing does not happen, the data IPs do not have their ownership changed to the target process. This is another overhead savings in push mode processing.

FIG. 15B depicts the control block structure changes when processing turbo data. The only changes from pull mode operation is the “Turbo Pointer” extension on the appropriate InPort control blocks. The InPort blocks become place holders for turbo extensions.

The turbo pointer contains control information about the associated exit. It actually is a class with the exit as one of its methods. Other methods such as FREEZE, THAW, and HOLD are available to the exit.

1.4.19 Functions

The present invention contains a major deviation from FBP architecture by introducing named functions which may be called by any process without being defined in a network diagram. These functions may perform any service and may be defined to run in simple or double-call modes. Two real examples are:
The file structure “Enumerate” process can generate a complex bracketed stream of directory and file information. It offers a function to decode the stream and, when used by a downstream process, significantly simplifies programming. The decoding of the data stream is inside the same process that creates the data stream. These simple call functions run under the calling process dispatch.
The “FileRead” process exposes double-call functions. The first call (“Read”) establishes the environment and schedules a dispatch of the host process which “opens” the file, and primes data buffers. The second call type performs a “GetData” under control of the calling process which transfers prepared data to the caller's data buffers. When a buffer is emptied the host function is signaled to prepare additional data.

1.4.19.1 Opening a Function

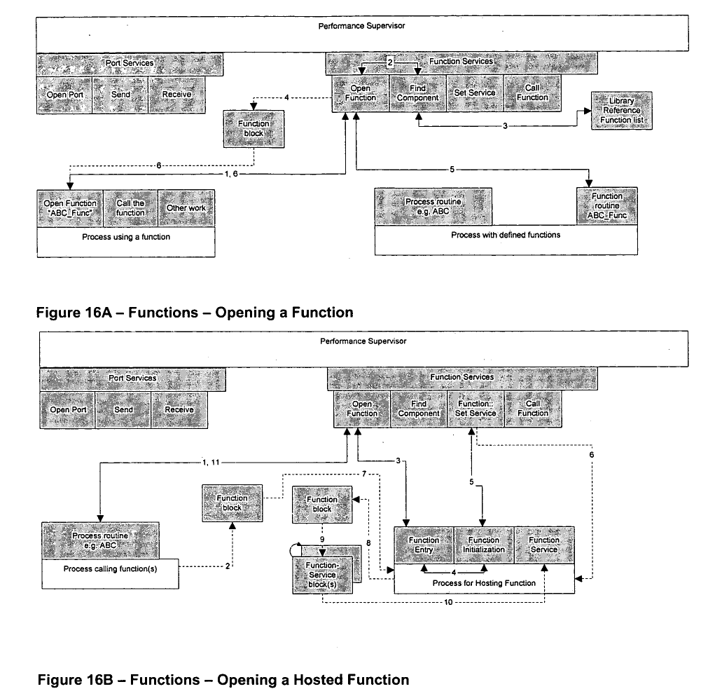

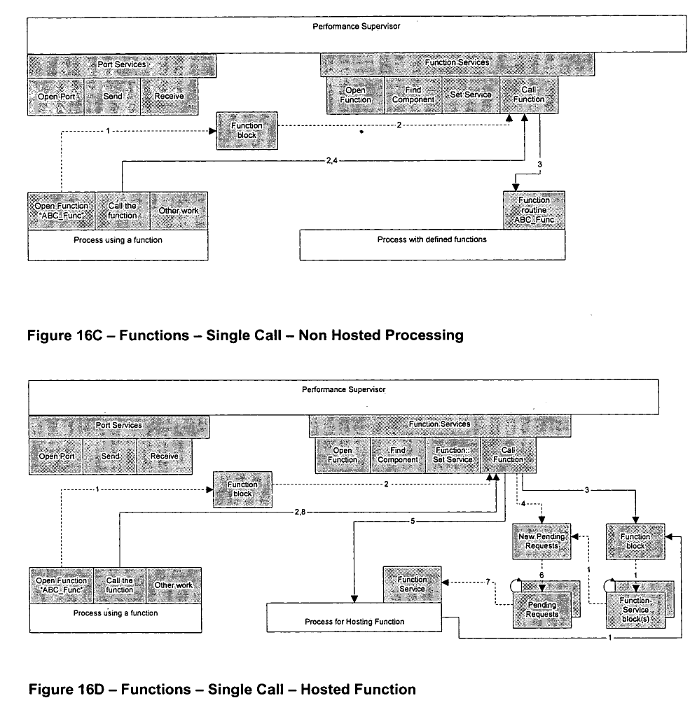

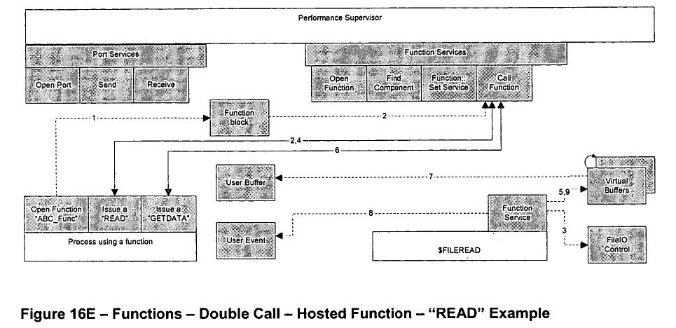

FIG. 16A depicts the flow when opening a function; the function may be local or hosted and if hosted may be a single-call or double-call type. The calling process need not know how the function operates, only how to call it.

To connect to a function called “ABC_Func” the operation is:
The requesting process issues an “Open” call (1) specifying the character name of the function requested.
Function Services “Open” locates the function name in the hierarchy of library references (3)
A function block will be created for the calling process. It contains Function Services control information and is a blind class exposing a “Call” method.
Open branches to the function routine with an “initialization” flag set. After necessary initialization control is returned to Open and then back to the caller (6) with the address of the function block (6).
The requesting process may make calls to the function and receive responses through three parameters that are passed to and from the function. Individual function specifications determine the values of those parameters.

FIG. 16B depicts the additional steps “Open” performs when the function is run with the assistance of a hosting process. The flow is:
The requesting process issues an “Open” call (1) specifying the character name of the function requested. All of the steps in FIG. 16A are followed (1—The open, 2—building the function block, 3—branching to the function and 4—starting the initialization code)
The function initialization code issues a “SetService” call (5) for each callable service to be established. The SetService call includes the name of the hosting process.
SetService will, for the first reference to a hosting process:
   Create the process control blocks for the host, and enqueue it for initial dispatch (6)
   Locate the callers function block and link it to the hosting process controls (7)
   Create a new function block for the host process (8)
SetService will, for each call, create a FunctionService control and hang it from the host function (9). It contains the entry point (10) of the appropriate service routine.
Control is returned to the calling process (11) with the function block established.

The hosting process is given a $ . . . name signifying a system process. It has no port connections and will not appear in the network definition. It may appear in network diagrams for informational purposes. There is no logical connection between the user process and the service routine except the pointer to the host process in the user side function block.

1.4.19.2 Using a Function

There are two types of services; hosted or non-hosted. Hosted functions may be single or double call types. FIGS. 16C-E depict these three operating modes. In all these diagrams it is understood that Open has completed and created the appropriate Function Block (1) in each diagram.

FIG. 16C depicts the flow for a non hosted function, which must be a single call type and always runs under the dispatch of the calling process. The flow is:
The user process issues a Function::Call method (2) passing the three user parameters.
Function Services branches to the function routine (3) with its address in the function block
The function routine performs its services. It may request a supervisor service that causes a suspend. It is the calling process that is suspended. Upon completion it returns to the caller (4) with updated variables.

FIG. 16D depicts the flow for a hosted function, using a single call method. Since hosted functions run under their own dispatch they require a thread-safe way to queue and process requests. This mode introduces a queuing method for pending requests. The flow is:
The user process issues a Function::Call method (2) passing the three user parameters.
Call processing detects the “hosted” flag in the function block and starts processing in hosted mode. It locates the host process function block (3) and scans the service blocks for the matching service name.
Associated with each service is a push down new work queue. Call processing builds a request block and pushes it onto the queue (4).
If the user supplied an event, it is used; if not Call processing creates an event for synchronization.
The hosting process new work event is posted (5) and, if not a user event, Call waits for the request to complete. On user events Call returns to the main process which may wait or check the event.
The host process, when dispatched, will dequeue all new requests. These requests are ordered and merged with any pending requests (6). The top request is taken (7) and processed.
As each request is completed the associated event is posted. This wakes up the Call, if the internal event is used, and Call returns to the user process (8).
This process continues until no work remains and the host process waits on the new work event.

FIG. 16E depicts the additional flow for a hosted function, using a two call method. Each individual call operates in the manner detailed in FIG. 16D above. This figure shows how a user may efficiently read data files by calling the read services of FILEREAD. The flow is:
The user has already opened the function “FileIO_Request” (1) establishing the function blocks associated with the user and host processes. Host process initialization has issued a SetService for “Read” and “GetData” services.
The user process issues a function Call method requesting “Read” (2) for a fully qualified file name (in windows terms; specified the drive, directories, and full filename). This call is converted to a request, queued on the host ($FILEREAD) work queue, the host process is posted, and the caller waits as it did not supply an event.
The host process starts on the request. It locates the requested file and opens an I/O service request (3). The call reply information is set (file found and file attributes including file size), and the user event posted restarting the user process (4).
The host function starts reading the file by allocating virtual buffer space and issuing read request(s) to fill the buffers (5). Depending on hardware configurations this activity is interlaced with (single processor) or concurrent with (multiple processor) user process operations. The host process goes idle waiting for another call request or I/O completion.
The user process has received control back after the “Read”. The return information indicates the request was started and the size of the data file. It prepares a user buffer area and issues another call “GetData” (6) to fill that buffer. This time it supplies an event which will be posted when the data is available so the call returns immediately after establishing a request and posting the host process. The user process does not wait on the event at this time instead does other processing and then issues a wait on a list of work items, one of which is the event for this call.
The host process is given control, dequeues and goes to the “GetData” service routine. If the file read operation has not completed GetData will mark the I/O request as a service request then go idle waiting completion. The GetData service will be re-entered by the host process when the I/O completes.
GetData service in the host process:
   Was called after the I/O had completed, or
   Was re-entered from the host process when I/O completes.

GetData will perform data manipulation as requested:
Separate records of text format, adding ending characters if necessary
Process a portion of the data if maximum size is requested
Perform format conversion i.e. ebcdic to ascii

GetData prepares the data as above and moves up to the amount requested into the user supplied buffer (7) then posts the user event (8). When a virtual buffer has been completed a new read request will be generated (9). This loop repeats until end-of-file is detected. The request for data will return an EOF condition and the user will issue a new Read or Close the function.

Many services can be configured to use functions. Some process types become complex when required to be in a network; these same processes may expose function services that become available to all processes. Some examples are:
A Graphical User Interface (GUI) may direct messages to a specific function/process
A database manager can service many users with a simplified interface
Read and write of files, real or in storage temporary.

### 1.5 CLOSING

The advantages of the present invention should be apparent in view of the detailed description of the invention that is provided above.

Those of ordinary skill in the art of business analysis can see improvements in transitioning business flow diagrams into FPB networks. Those of ordinary skill in the arts of Information Technology management and programming can see significant improvements using pre-tested, core competency efficient processes and more fully utilizing existing computer resources. Those of ordinary skill in the art of distributed systems can see the simplicity of distributing applications across many computing nodes.

It is important to note that while the present invention has been described in the context of a fully functioning data processing system, those of ordinary skill in the art will appreciate that the processes of the present invention are capable of being distributed in the form of a computer readable medium of instructions and a variety of other forms and that the present invention applies equally regardless of the particular type of signal bearing media actually used to carry out the distribution. Examples of computer readable media include media such as EPROM, ROM” tape, paper, floppy disk, hard disk drive, RAM, CD-ROMs, DVDs and flash memory and transmission-type media such as digital and analog communications links.

The description of the present invention has been presented for purposes of illustration and description but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method, data processing system, and computer program product for improving the services available to and execution performance of a FBP application in a data processing system, wherein the method offers services to the application that permit more work to be performed with less overhead, eliminate circumstances where the computer waits for services while other work may be performed, and permit dynamic adjustment in execution priorities for time-dependant processes.

2. The method, data processing system, and computer program product of claim 1, wherein with no changes in the user application, it will dynamically recognize the number of processors available in the executing system establishing a dispatching environment for each of those available processors.

3. The method, data processing system, and computer program product of claim 1, wherein an application execution may be distributed across multiple execution environments. This is achieved through establishing connections with different systems and exchanging services including but not limited to application networks, application processes and execution libraries, message libraries, and data packets.

4. The method, data processing system, and computer program product of claim 1, wherein data Input/Output (I/O) services are offered to the application.

5. The method, data processing system, and computer program product of claim 1, wherein asynchronous I/O operations are simulated on data processing systems that do not support asynchronous I/O operations.

6. The method, data processing system, and computer program product of claim 1, wherein pure asynchronous I/O operations are performed on data processing systems that support asynchronous I/O operations

7. The method, data processing system, and computer program product of claim 1, wherein ‘virtual buffers’ are utilized, where appropriate, to reduce system overhead.

8. The method, data processing system, and computer program product of claim 1, wherein the optimal I/O methods for the executing data processing system are selected without change to the application requesting that I/O operation.

9. The method, data processing system, and computer program product of claim 1, wherein the application may request and receive concurrent I/O operations without intervening blocking.

10. The method, data processing system, and computer program product of claim 1, wherein application I/O requests may specify a control field (event) which will be changed when the I/O operation completes (posted), and may be waited upon until it is posted.

11. The method, data processing system, and computer program product of claim 1, wherein I/O operations may be requested on temporary files which are memory backed rather than requiring physical I/O operations which require more clock time and data processing system overhead.

12. The method, data processing system, and computer program product of claim 1, wherein the application process may prepare for (open) and terminate those preparations (close) I/O operations to a data processing system file, overriding default settings.

13. The method, data processing system, and computer program product of claim 1, wherein the application process may request I/O services including, but not limited to requesting data from a file (READ), Writing data to a file (WRITE), checking the status of an operations (CHECK), and repositioning for the next operation (SEEK).

14. The method, data processing system, and computer program product of claim 1, wherein one or more routines may be specified (NoWorkList) to receive control when all processes are waiting for something else to happen (deadlock). This routine may wait for some external action, such as a message down a pipe, or may inspect the operational network for full port conditions and insert corrective processes, or may execute a background function to utilize the idle processor.

15. The method, data processing system, and computer program product of claim 1, wherein a process may request immediate entry to the NoWorkList to provide application wide synchronization.

16. The method, data processing system, and computer program product of claim 1, wherein a special dynamic buffering process may be inserted into a network preventing deadlock conditions caused by excessive information packets (IPs). The dynamic buffering process will, progressively, save excessive IPs in memory until the downstream process starts accepting IPs, compress in-memory IPs into fixed sized memory chunks, write compressed chunks to a temporary file or the paging dataset as defaulted, reverse the previous functions supplying IPs in the original order.

17. The method, data processing system, and computer program product of claim 1, wherein a real-time, time dependant or other process, may have its priority boosted or dropped to meet service level agreements. A process may request its own priority, or the priority of another process, to be set higher, set lower, or set to increase steadily as it takes longer to complete.

18. The method, data processing system, and computer program product of claim 1, wherein a network which is named but not defined in an application may be loaded dynamically at execution time (dynamic network). The dynamic network may carry its own services such as message library, functions, link libraries, and lower level networks.

19. The method, data processing system, and computer program product of claim 1, wherein free IPs are maintained in pools of preset sizes for fast allocation and return. Each pooled IP carries a data overrun flag, which when found altered, triggers an error condition.

20. The method, data processing system, and computer program product of claim 1, wherein a message service permits messages from many sources to be combined into a single log.

21. The method, data processing system, and computer program product of claim 1, wherein messages support substitution. The calling process, including called services, may request a message by message-number, and supply values for substitution into the base message text.

22. The method, data processing system, and computer program product of claim 1, wherein each message may specify the order of substitutions and may specify the same value to appear multiple times in the message text.

23. The method, data processing system, and computer program product of claim 1, wherein multiple like named message libraries may be specified and selected by a language code. A message in one language will likely specify different text and order of substitution.

24. The method, data processing system, and computer program product of claim 1, wherein a message library may be associated with a unique process, network, or distribution library (DLL). Multiple message libraries with the same name are supported and are searched in order of closeness to the running process, that is process first, then contained network, then contained DLL, then the default system library. A message not found in one library may be located in a lower level library.

25. The method, data processing system, and computer program product of claim 1, wherein a process may monitor a directory or file changes through non-blocking operations. Changes are reported in a stream of IPs to an open port on the calling process. The process specifies the level of monitoring desired.

26. The method, data processing system, and computer program product of claim 1, wherein the method offers services to the application that permit data to be pushed from one process to another with reduced overhead, referred in this invention as a turbo port and a turbo exit.

27. The method, data processing system, and computer program product of claim 1, wherein a process may send data to an output port in a standard manner without knowing the processing mode of the receiving input port. I.e. turbo or normal.

28. The method, data processing system, and computer program product of claim 1, wherein a process may “Freeze” the input port thereby preventing any upstream process from pushing additional data into the turbo exit. The data is queued pending further action.

29. The method, data processing system, and computer program product of claim 1, wherein a process may “Thaw” a previously frozen port. Any data pending due to a freeze will be pushed to the turbo exit followed by, within the same call or subsequent calls, any new data arriving at the input port.

30. The method, data processing system, and computer program product of claim 1, wherein a process may “Hold” any data already pushed into a turbo port. This data is returned to the input port for future processing.

31. The method, data processing system, and computer program product of claim 1, wherein a process may query an output port to determine the “Limit” or maximum number of Information Packets (IPs) that will be accepted before the port suspends or sets an event.
